(19) United States
(12) Patent Application Publication
(10) Pub. No.: US 2026/0168863 A1
(43) Pub. Date: Jun. 18, 2026

(54) LARGE LANGUAGE MODEL (LLM) CONTROL BASED ON DEVICE TEMPERATURE

(71) Applicant: QUALCOMM Incorporated, San Diego, CA (US)

(72) Inventors: Aaquib Reza KHAN, San Diego, CA (US); Wesley James HOLLAND, Encinitas, CA (US); Yuyu SU, San Diego, CA (US); Titash RAKSHIT, Austin, TX (US); Nikhil Kumar KANSAL, San Diego, CA (US); Simon Peter William BOOTH, San Diego, CA (US)

(21) Appl. No.: 18/978,868

(22) Filed: Dec. 12, 2024

(51) Int. Cl. G01K 1/022; G06F 16/332; G06F 40/284

(52) U.S. Cl. CPC G01K 1/022; G06F 16/3326; G06F 40/284

(57) ABSTRACT

A device includes a memory device configured to store output data of a large language model (LLM). The device also includes one or more processors configured to obtain, from a temperature sensor, a first sensor output indicating a first temperature associated with the device. The one or more processors are configured to, based on the first temperature and first output data of the LLM, control generation of second output data by the LLM.

### I. FIELD

The present disclosure is generally related to large language models (LLMs).

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate large language models (LLMs) for various applications. For example, LLMs can be used for customer service, user support, content creation, education, translation, data analysis, medical assistance, creative writing, etc. Running an LLM for multiple queries and large responses can lead to a rapid increase in junction temperature resulting in a higher surface temperature of the computing device that can cause user discomfort.

### III. SUMMARY

According to one implementation of the present disclosure, a device includes a memory device configured to store output data of a large language model (LLM). The device also includes one or more processors configured to obtain, from a temperature sensor, a first sensor output indicating a first temperature associated with the device. The one or more processors are also configured to, based on the first temperature and first output data of the LLM, control generation of second output data by the LLM.

According to another implementation of the present disclosure, a method includes obtaining, from a temperature sensor, a sensor output indicating a temperature associated with a first device. The method also includes based on the temperature and first output data of a large language model (LLM), controlling generation of second output data by the LLM.

According to another implementation of the present disclosure, a non-transitory computer-readable medium stores instructions that, when executed by one or more processors, cause the one or more processors to obtain, from a temperature sensor, a sensor output indicating a temperature associated with a device. The instructions further cause the one or more processors to, based on the temperature and first output data of a large language model (LLM), control generation of second output data by the LLM.

According to another implementation of the present disclosure, an apparatus includes means for obtaining a sensor output from a temperature sensor, the sensor output indicating a temperature associated with a device. The apparatus further includes means for controlling generation of second output data by the LLM, the generation of the second output data controlled based on the temperature and first output data of a large language model (LLM).

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to perform temperature-based control of a large language model (LLM), in accordance with some examples of the present disclosure.

FIG. 2 is a diagram of an illustrative aspect of another system operable to perform temperature-based control of an LLM, in accordance with some examples of the present disclosure.

FIG. 3 is a diagram of an illustrative aspect of operation of one or more components of an LLM-based audio generator of the systems of FIG. 1 or 2, in accordance with some examples of the present disclosure.

FIG. 4 is a diagram of a particular implementation of a method of temperature-based control of an LLM that may be performed by the systems of FIG. 1 or 2, in accordance with some examples of the present disclosure.

FIG. 5A is a diagram of a particular implementation of a method of audio generation that may be performed by the LLM-based audio generator of the systems of FIG. 1 or 2, in accordance with some examples of the present disclosure.

FIG. 5B is a diagram of a particular implementation of another method of audio generation that may be performed by the LLM-based audio generator of the systems of FIG. 1 or 2, in accordance with some examples of the present disclosure.

FIG. 6 is a diagram of an illustrative aspect of operation of components of the systems of FIG. 1 or 2, in accordance with some examples of the present disclosure.

FIG. 7 illustrates an example of an integrated circuit operable to perform temperature-based control of an LLM, in accordance with some examples of the present disclosure.

FIG. 8 is a diagram of a mobile device operable to perform temperature-based control of an LLM, in accordance with some examples of the present disclosure.

FIG. 9 is a diagram of a headset operable to perform temperature-based control of an LLM, in accordance with some examples of the present disclosure.

FIG. 10 is a diagram of a wearable electronic device operable to perform temperature-based control of an LLM, in accordance with some examples of the present disclosure.

FIG. 11 is a diagram of a mixed reality or augmented reality glasses device operable to perform temperature-based control of an LLM, in accordance with some examples of the present disclosure.

FIG. 12 is a diagram of earbuds operable to perform temperature-based control of an LLM, in accordance with some examples of the present disclosure.

FIG. 13 is a diagram of a voice-controlled speaker system operable to perform temperature-based control of an LLM, in accordance with some examples of the present disclosure.

FIG. 14 is a diagram of a camera operable to perform temperature-based control of an LLM, in accordance with some examples of the present disclosure.

FIG. 15 is a diagram of a headset, such as a virtual reality, mixed reality, or augmented reality headset, operable to perform temperature-based control of an LLM, in accordance with some examples of the present disclosure.

FIG. 16 is a diagram of a first example of a vehicle operable to perform temperature-based control of an LLM, in accordance with some examples of the present disclosure.

FIG. 17 is a diagram of a second example of a vehicle operable to perform temperature-based control of an LLM, in accordance with some examples of the present disclosure.

FIG. 18 is a diagram of a particular implementation of a method of temperature-based control of an LLM that may be performed by the device of FIG. 1, in accordance with some examples of the present disclosure.

FIG. 19 is a block diagram of a particular illustrative example of a device that is operable to perform temperature-based control of an LLM, in accordance with some examples of the present disclosure.

### V. DETAILED DESCRIPTION

Typically, a device includes a controller that generates a first input embedding based on an input prompt and provides the first input embedding to an LLM to generate first output data during a first iteration of the LLM. The controller stores the first output data, including one or more first output tokens, in an output token buffer. Subsequently, the controller generates an input embedding based on previous output data of the LLM and provides the input embedding to the LLM to generate next output data during another iteration of the LLM. The controller stores the second output data, including one or more second output tokens, in the output token buffer. Concurrently with storing output tokens in the output token buffer, the controller provides a subset of the output tokens from the output token buffer to an audio generator to generate audio data. Running such an LLM for many iterations to generate longer responses for possibly multiple input prompts can lead to an increase in junction temperature resulting in a higher surface temperature of the computing device that can cause user discomfort.

Systems and methods of temperature-based control of an LLM are disclosed. For example, the controller controls generation of output by the LLM based on a sensor output from a temperature sensor that indicates a temperature associated with the device. In some examples, the controller selectively, based on the temperature, pauses generation of output data at the LLM by adding a delay prior to providing an input embedding to the LLM. In some examples, the controller selectively, based on the temperature, pauses operation of the audio generator to stop removal of output tokens from the output token buffer so that generation of the output data at the LLM is paused while the output token buffer is full. In some examples, the controller provides the input embedding and the sensor output to the LLM. In some other examples, the controller generates the input embedding based on the sensor output. In some aspects, the LLM is configured to generate shorter responses when the sensor output indicates a higher than threshold temperature. Controlling generation of output by the LLM can be used to reduce temperature of the device when the temperature is higher and can be used to improve performance (e.g., faster and longer responses) when the temperature is lower.

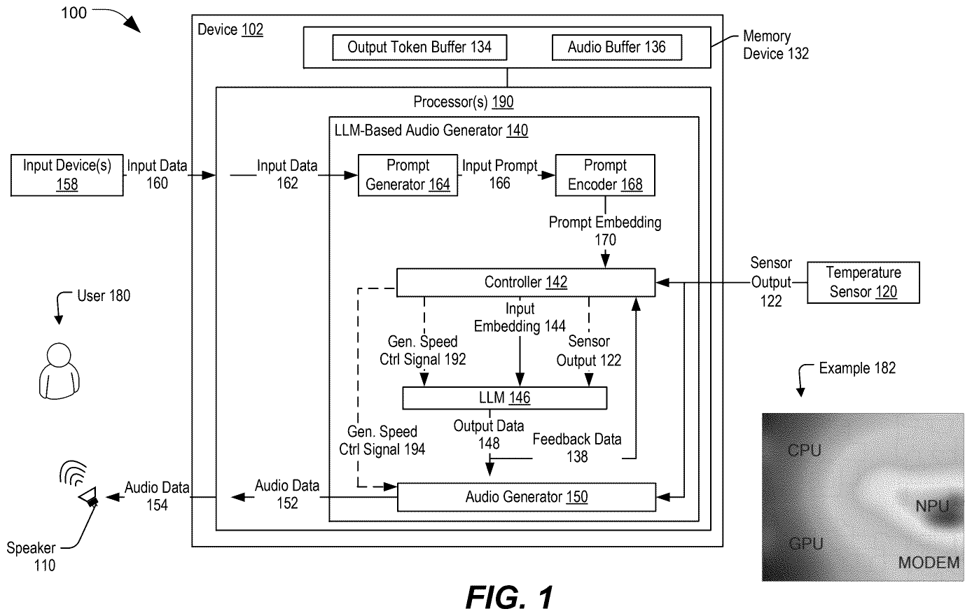

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, receiving, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Referring to FIG. 1, a particular illustrative aspect of a system 100 is shown that is configured to perform temperature-based control of a large language model (LLM), in accordance with some examples of the present disclosure. The system 100 includes a device 102 that is coupled to a temperature sensor 120, a speaker 110, one or more input devices 158, or a combination thereof. In some embodiments, the temperature sensor 120 is coupled to or included in one or more components of the device 102. In an example, the one or more components of the device 102 include at least one of a processor, a transistor junction of a processor, a diode, an oscillator, a resistor, an audio codec, a modem, or a memory component.

Optionally, in some embodiments, the temperature sensor 120 includes at least one of an analog temperature sensor, a digital temperature sensor, a thermal diode, or a thermistor. Optionally, in some embodiments, the temperature sensor 120 is configured to detect conditions that can be used to infer temperature. In an example, the temperature sensor 120 is configured to generate sensor output based at least in part on detection of a temperature coefficient of a resistive component of the device 102, voltage characteristics of a diode of the device 102, current characteristics of the diode, voltage characteristics of a junction of the device 102, current characteristics of the junction, an oscillation frequency of an oscillator of the device 102, thermal noise of a resistor of the device 102, material expansion or contraction of the device 102, temperature dependent dielectric properties of the device 102, or magnetic field measurements of the device 102.

In some aspects, the one or more input devices 158 include a microphone, a camera, a touchpad, a mouse, a keyboard, or a combination thereof. The temperature sensor 120, the speaker 110, and the one or more input devices 158 are depicted as external to the device 102 as an illustrative example; in other examples, the temperature sensor 120, the speaker 110, the one or more input devices 158, or a combination thereof can be integrated in the device 102.

The device 102 includes one or more processors 190 coupled to a memory device 132. The one or more processors 190 include an LLM-based audio generator 140 that includes a controller 142 coupled to the temperature sensor 120 and coupled to an LLM 146. Optionally, in some embodiments, the LLM-based audio generator 140 includes a prompt generator 164 coupled via a prompt encoder 168 to the controller 142. In some embodiments, the LLM-based audio generator 140 includes an audio generator 150 that is optionally coupled to the controller 142, the LLM 146, or both.

The prompt generator 164 is configured to generate an input prompt 166 based on input data 162. The input data 162 is based on input data 160 from the one or more input devices 158. The prompt encoder 168 is configured to encode the input prompt 166 to generate a prompt embedding 170. The controller 142 is configured to generate an initial input embedding 144 based on the prompt embedding 170, and to generate a subsequent input embedding 144 based on feedback data 138 from the LLM 146. In some aspects, the controller 142 is configured to, concurrently with providing the input embedding 144 to the LLM 146, provide the sensor output 122 from the temperature sensor 120 to the LLM 146. In some embodiments, the LLM 146 is configured to receive the sensor output 122 from the temperature sensor 120 independently of the controller 142. Optionally, in some aspects, the controller 142 is configured to generate the initial input embedding 144, the subsequent input embedding 144, or both, further based on sensor output 122 from the temperature sensor 120. The LLM 146 is configured to process an input embedding 144, and optionally the sensor output 122, to generate output data 148 and to provide the output data 148 as the feedback data 138 to the controller 142. The audio generator 150 is configured to generate audio data 152 based on the output data 148.

The controller 142, the audio generator 150, or both, are configured to control, based on the sensor output 122, generation of output data (e.g., the output data 148, the audio data 152, or both) by the LLM 146. Optionally, in some embodiments, the controller 142 is configured to selectively, based on the sensor output 122, pause or resume generation of the output data 148 at the LLM 146, adjust a generation rate of the output data 148 at the LLM 146, adjust a length of the output data 148 generated by the LLM 146, or a combination thereof. Optionally, in some embodiments, the controller 142 (or the audio generator 150) is configured to selectively, based on the sensor output 122, pause or resume generation of the audio data 152 at the audio generator 150, adjust a generation rate of the audio data 152 at the audio generator 150, or a combination thereof. In some aspects, pausing or reducing a generation rate of the output data 148, the audio data 152, or both, can reduce a temperature associated with the device 102. In an example, when the generation rate of the output data 148 at the LLM 146 is paused, a junction temperature of a neural processing unit (NPU) that uses the LLM 146 falls at a first rate (e.g., from 70 degrees Celsius to 40 degrees Celsius in less than 3 seconds). A surface temperature of the device 102 generally lags behind the junction temperature. For instance, the surface temperature falls at a second rate that is, in some examples, slower than the first rate.

The memory device 132 includes an output token buffer 134 that is configured to store output of the LLM 146. Optionally, in some embodiments, the memory device 132 also includes an audio buffer 136 that is configured to store output of the audio generator 150. Optionally, in some embodiments, the LLM 146 is configured to store output tokens of the output data 148 in the output token buffer 134, and the audio generator 150 is configured to retrieve the output tokens from the output token buffer 134 to generate audio data 152. Optionally, in some embodiments, the audio generator 150 is configured to store the audio data 152 in the audio buffer 136, and the one or more processors 190 are configured to retrieve the audio data 152 from the audio buffer 136 for playout via the speaker 110. For example, the one or more processors 190 are configured to generate audio data 154 based on the audio data 152 and to provide the audio data 154 to the speaker 110. The speaker 110 is configured to output audio corresponding to the audio data 154.

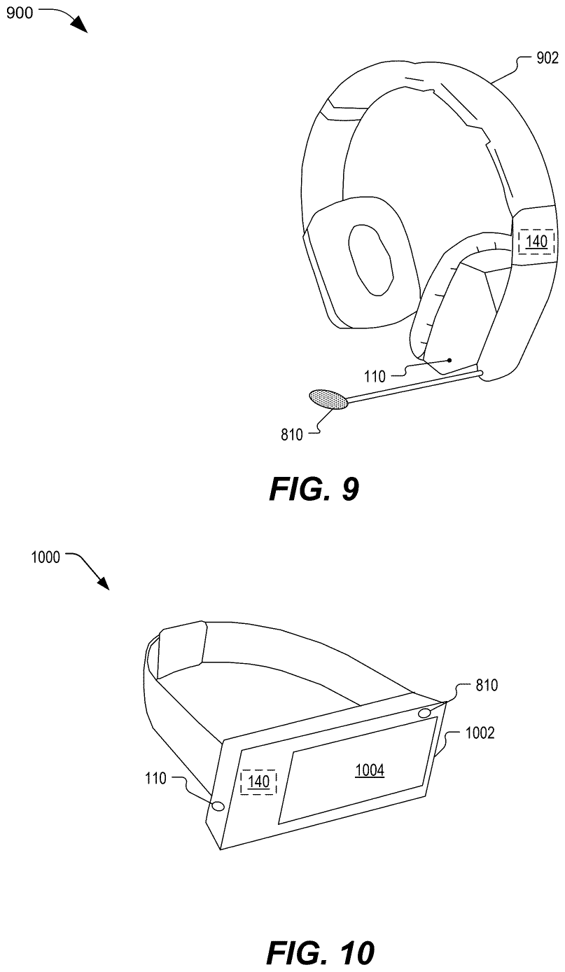

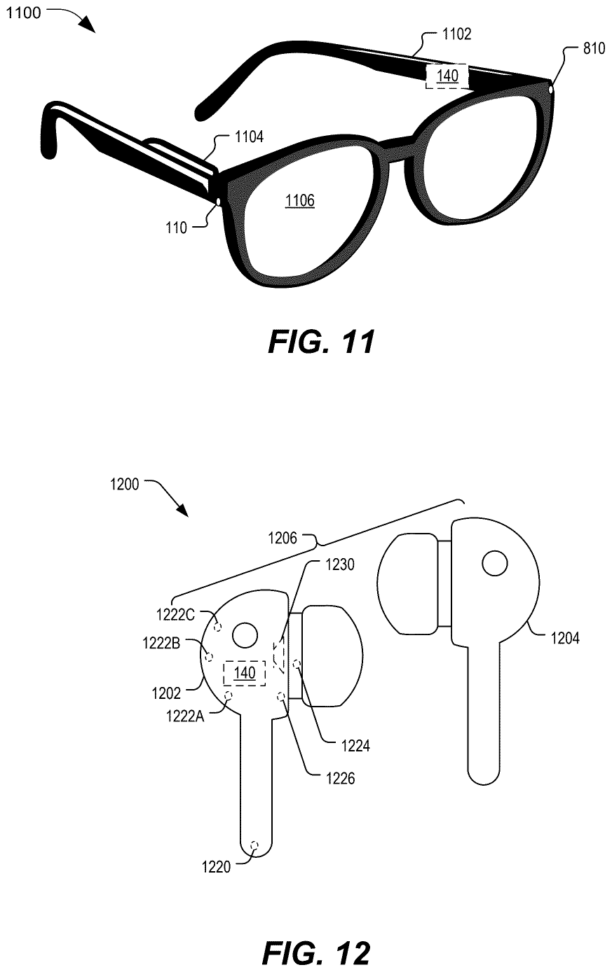

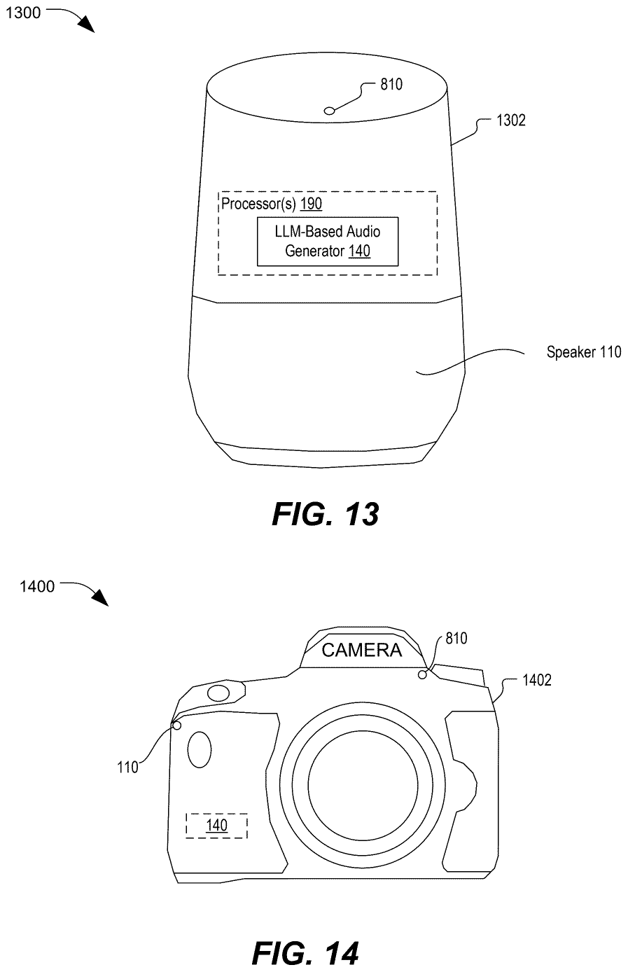

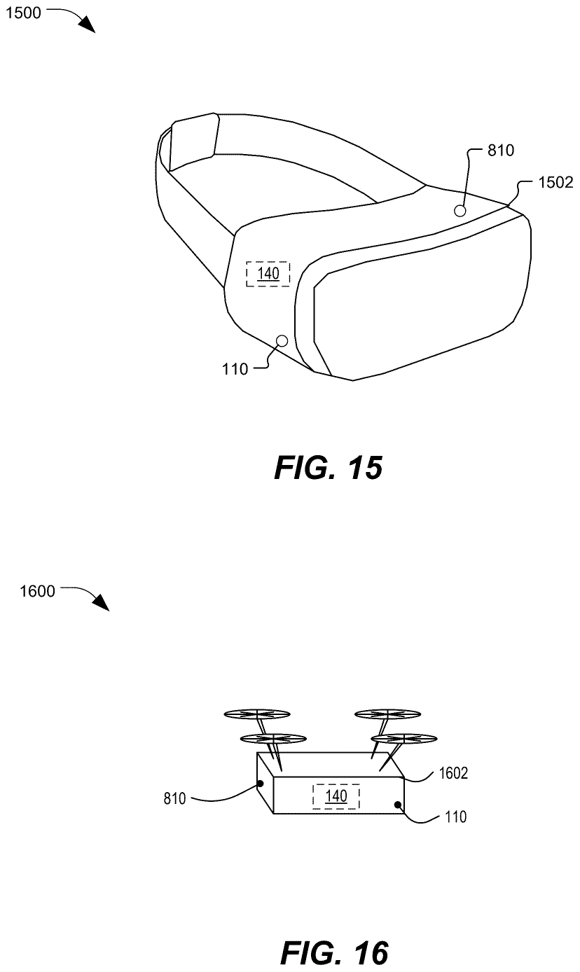

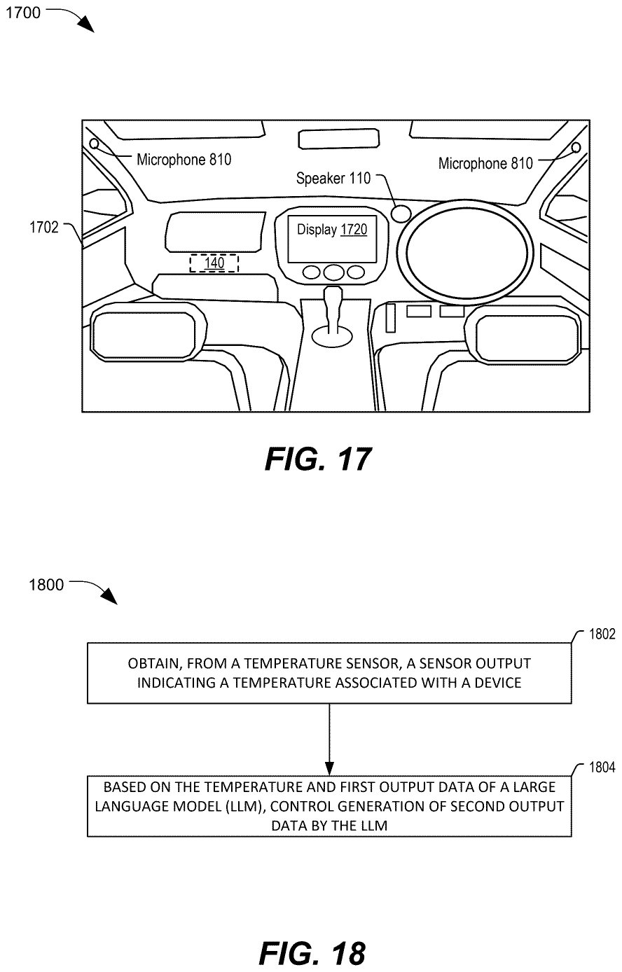

In some embodiments, the device 102 corresponds to or is included in one of various types of devices. In an illustrative example, the one or more processors 190 are integrated in a headset device that includes the speaker 110, such as described further with reference to FIG. 9. In other examples, the one or more processors 190 are integrated in at least one of a mobile phone or a tablet computer device, as described with reference to FIG. 8, a wearable electronic device, as described with reference to FIG. 10, a mixed reality or augmented reality glasses device, as described with reference to FIG. 11, earbuds, as described with reference to FIG. 12, a voice-controlled speaker system, as described with reference to FIG. 13, a camera device, as described with reference to FIG. 14, or a virtual reality, mixed reality, or augmented reality headset, as described with reference to FIG. 15. In another illustrative example, the one or more processors 190 are integrated into a vehicle that also includes the speaker 110, such as described further with reference to FIG. 16 and FIG. 17.

During operation, the LLM-based audio generator 140 receives input data 162. In a particular example, the input data 162 is based on input data 160 from the one or more input devices 158. To illustrate, the input data 160 can include image data from a camera, audio data from a microphone, keystroke data from a keyboard, touch data from a touch screen, or a combination thereof.

The prompt generator 164 generates an input prompt 166 based on the input data 162. For example, the input data 162 includes image data indicating a user 180 pointing to an object (e.g., a hammer) and keystroke data indicating a question (e.g., “What is this used for?”), and the input prompt 166 corresponds to a text query (e.g., a question, a comment, etc.) that is based on the object and the question. In some embodiments, the input prompt 166 (e.g., “What is this hammer used for?”) can indicate context (e.g., a detected object, a detected user, a detected time-of-day, etc.). The prompt generator 164 provides the input prompt 166 to the prompt encoder 168.

The prompt encoder 168 encodes the input prompt 166 to generate a prompt embedding 170 and provides the prompt embedding 170 to the controller 142. For example, the input prompt 166 includes a plurality of tokens (e.g., “What,” “is,” “this,” “hammer,” “used,” “for,” and “?”) and the prompt embedding 170 includes a plurality of respective token embeddings. In a particular aspect, a “token” includes a unit of text that corresponds to a word, a part of a word, an individual character, etc., and a respective “token embedding” corresponds to a mathematical representation (e.g., a vector) of the token in a feature space. In a particular aspect, token embeddings corresponding to tokens with similar meanings are closer to each other in the feature space. The input data 160 received from the one or more input devices 158 is provided as an illustrative example; in some other examples the input data 160, the input data 162, the input prompt 166, the prompt embedding 170, or a combination thereof, can be generated by one or more components of the one or more processors 190.

The controller 142 receives the sensor output 122 from the temperature sensor 120. In an example 182, a temperature profile of a system-on-chip (SOC) is depicted. A neural processing unit (NPU) that uses (e.g., runs) the LLM 146 can have a higher temperature (e.g., illustrated with a darker color) than some other components of the device 102. In a particular aspect, the temperature sensor 120 can detect junction temperature at different locations of the device 102, such as locations thermally coupled to one or more processing cores of the NPU. In a particular aspect, a surface temperature (e.g., a display temperature, a back cover temperature, or both) of the device 102 is directly correlated to the detected junction temperature.

The sensor output 122 (e.g., a first sensor output) indicates a first temperature associated with the device 102 at a first time. For example, the sensor output 122 indicates a junction temperature, a surface temperature, or both, of the device 102 at the first time. In some examples, the controller 142 estimates the surface temperature based on a detected junction temperature. During an initial iteration, the controller 142 generates an input embedding 144 based at least in part on the prompt embedding 170. Optionally, in some embodiments, the controller 142 also provides the sensor output 122 (e.g., the first temperature) to the LLM 146. Optionally, in some embodiments, the input embedding 144 is also based on the first temperature. For example, the input embedding 144 includes the prompt embedding 170 combined with a temperature embedding representing the first temperature.

The LLM-based audio generator 140 uses the LLM 146 to process the input embedding 144, and optionally the sensor output 122 (e.g., the first temperature), to generate output data 148 (e.g., first output data of the first iteration). The LLM-based audio generator 140 provides the output data 148 as feedback data 138 to the controller 142, and also provides the output data 148 to the audio generator 150. The output data 148 includes one or more output tokens. In some embodiments, the LLM-based audio generator 140 uses the LLM 146 to generate output data 148 at a particular generation rate (e.g., 13 tokens per second) that can be selectively adjusted based on temperature. In an example, the output data 148 includes output tokens representing at least a partial response (e.g., “This hammer can be used for”) to the input prompt 166 (e.g., “What is this hammer used for?”). The LLM-based audio generator 140 stores the output tokens of the output data 148 in the output token buffer 134.

During a subsequent iteration, the controller 142 receives the sensor output 122 (e.g., a second sensor output) from the temperature sensor 120 indicating a second temperature associated with the device 102 at a second time. The controller 142 controls, based at least in part on the feedback data 138, generation of the output data 148 (and hence audio data 152) by the LLM 146. For example, the controller 142 generates an input embedding 144 based on the feedback data 138 received from a prior iteration, and optionally based on the sensor output 122 (e.g., the second temperature). Optionally, in some embodiments, the controller 142 provides the sensor output 122 (e.g., the second temperature) to the LLM 146. The LLM-based audio generator 140 uses the LLM 146 to process the input embedding 144, and optionally the sensor output 122 (e.g., the second temperature), to generate output data 148 (e.g., second output data of the subsequent iteration). The LLM-based audio generator 140 provides the output data 148 as the feedback data 138 to the controller 142 and provides the output data 148 to the audio generator 150. For example, the output data 148 includes output tokens representing a subsequent portion of a response (e.g., “hanging a painting”) to the input prompt 166. The LLM-based audio generator 140 stores the output tokens in the output token buffer 134.

The iterations continue until the controller 142 determines that a stop condition is satisfied. For example, the controller 142, in response to determining that the response to the input prompt 166 has been completed, determines that the stop condition is satisfied. In another example, the controller 142 determines that the stop condition is satisfied based on determining that at least a threshold count of iterations have been performed, a threshold time has elapsed since an initial iteration, a lower than threshold confidence value is associated with the output data 148, or a combination thereof.

Concurrently with the LLM-based audio generator 140 adding the output tokens to the output token buffer 134, the audio generator 150 retrieves one or more of the output tokens from the output token buffer 134 and generates audio data 152 corresponding to an audio representation of the retrieved output tokens. In a particular aspect, the one or more processors 190 generate audio data 154 based on the audio data 152 and provide the audio data 154 to the speaker 110 for playout. In some aspects, the one or more processors 190 provide output data based on the audio data 152 to a storage device, a network device, a user device, an audio playout device, or a combination thereof.

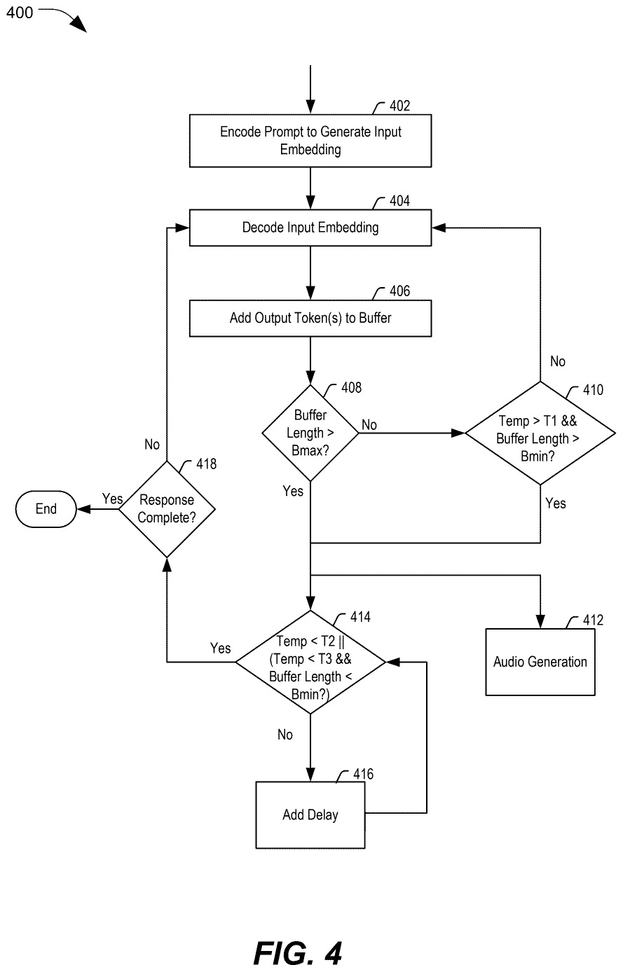

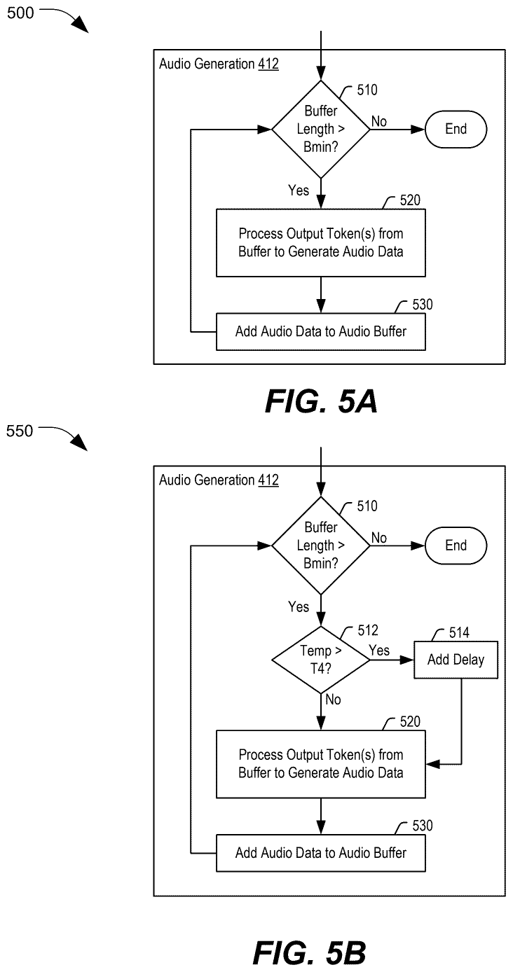

During the described iterations, the controller 142 selectively adjust, based on the temperature indicated by the sensor output 122, generation of output data (e.g., the output data 148, the audio data 152, or both) by the LLM 146, as further described with reference to FIGS. 4-5B. For example, in some of the embodiments in which the input embedding 144 is based on temperature, the LLM 146 adjusts a length of the output data 148 based on the temperature. To illustrate, the output data 148 of the first iteration has a first length that is based on the first temperature, and the output data 148 of the subsequent iteration has a second length that is based on the second temperature. If the second temperature is greater than a temperature threshold, the second length is less than the first length, less than a length threshold, or both. As an illustrative example, if the second temperature is less than or equal to the temperature threshold, the LLM 146 generates a first version of the output data 148 (e.g., “hammering a nail in the wall to hang a painting”) for the subsequent iteration. Alternatively, if the second temperature is greater than the temperature threshold, the LLM 146 generates a second version of the output data 148 (e.g., “hanging a painting”) for the subsequent iteration that is shorter than the first version. A single temperature threshold is described as an illustrative example, in other examples the LLM 146 can generate various length responses based on multiple temperature thresholds. To illustrate, the LLM 146 can generate a longer response if the temperature is less than a lower threshold, a medium-length response if the temperature is between the lower threshold and a higher threshold, and a shorter response if the temperature is greater than the higher threshold. In some aspects, the controller 142 configures (e.g., adjusts a configuration setting of) the LLM 146 based on the temperature so that the LLM 146 generates the output data 148 having a particular length corresponding to the temperature.

In some embodiments, the controller 142 selectively adjusts, based on the temperature indicated by the sensor output 122, a generation rate of the LLM 146. In some aspects, adjusting the generation rate of the LLM 146 corresponds to pausing and subsequently resuming generation of the output data 148 at the LLM 146, changing a speed at which the LLM 146 processes the input embedding 144 to generate the output data 148, or a combination thereof. Optionally, in some embodiments, the controller 142 sends a generation speed control signal 192 to the LLM 146 to adjust the generation rate of the LLM 146, and the LLM 146 adjusts the generation rate of the output data 148 based on the generation speed control signal 192. In an example, the controller 142, based on determining that a first temperature indicated at a first time by the sensor output 122 is greater than a first temperature threshold, sends the generation speed control signal 192 indicating a first value (e.g., 0) to pause generation of the output data 148 at the LLM 146. The controller 142, based on determining that a second temperature indicated at a second time by the sensor output 122 is less than or equal to a second temperature threshold, sends the generation speed control signal 192 indicating a second value (e.g., 1) to resume generation of the output data 148 at the LLM 146. In some examples, the first temperature threshold is equal to the second temperature threshold. In other examples, the first temperature threshold is higher than the second temperature threshold.

Optionally, in some embodiments, the controller 142 is configured to pause the generation of the output data 148 for a pre-determined pause duration that is based on the temperature. For example, the controller 142, in response to determining that a temperature indicated by the sensor output 122 is greater than a first threshold, pauses the generation of the output data 148 for a first pre-determined pause duration. Alternatively, the controller 142, in response to determining that the temperature is less than or equal to the first threshold and greater than a second threshold, pauses the generation of the output data 148 for a second pre-determined pause duration that is shorter than the first pre-determined pause duration. In some embodiments, the controller 142 selectively adjusts the generation rate of the output data 148 at the LLM 146 based on a temperature difference between a temperature indicated by the sensor output 122 and a temperature threshold. For example, the controller 142 selects a pre-determined pause duration corresponding to the temperature difference.

Optionally, in some embodiments, the controller 142 dynamically determines a pause duration based on a count of output tokens of the output data 148 available in the output token buffer 134. For example, the controller 142, based at least in part on determining that a count of output tokens of the output data 148 stored in the output token buffer 134 is less than a token count threshold, determines that the pause duration has ended and resumes generation of the output data 148. In an example, the controller 142 resumes generation of the output data 148 to prevent a disruption in generation of the audio data 152 if the count of output tokens stored in the output token buffer 134 is too low for audio generation.

In some aspects, the controller 142, based on determining that the second temperature is greater than a third temperature threshold, sends the generation speed control signal 192 indicating a value (e.g., 5) to configure the LLM 146 to generate the output data 148 at the LLM 146 at a first generation speed to reduce a generation rate of the output data 148. Alternatively, the controller 142, based on determining that the second temperature is less than or equal to the third temperature threshold, sends the generation speed control signal 192 indicating a value (e.g., 13) to configure the LLM 146 to generate the output data 148 at the LLM 146 at a second generation speed (e.g., 13 output tokens per second) that is greater than the first generation speed (e.g., 5 output tokens per second). In some embodiments, the second temperature threshold is greater than the third temperature threshold.

In some examples, the controller 142 slows down the generation speed of the LLM 146 and, if the temperature keeps rising, the controller 142 pauses generation of the output data 148. Similarly, the controller 142 resumes generation of the output data 148 when the temperature falls, after a pause duration, or both. If the temperature continues to fall, the controller 142 speeds up the generation speed of the LLM 146.

Optionally, in some embodiments, the LLM 146 obtains the sensor output 122 from the controller 142 or the temperature sensor 120, and performs similar operations described with reference to the controller 142 to adjust the generation rate of the output data 148 based on the temperature. For example, the LLM 146 compares the temperature to one or more thresholds and performs corresponding operations to selectively adjust the generation rate of the output data 148.

In some embodiments, adjusting the generation rate of output data of the LLM 146 includes selectively adjusting the generation rate of the audio data 152 at the audio generator 150 based on the temperature indicated by the sensor output 122. In a particular aspect, selectively adjusting the generation rate of the audio data 152 at the audio generator 150 based on the temperature can include one or more similar operations described with reference to adjusting the generation rate of the output data 148 at the LLM 146 based on the temperature. For example, updating the generation rate of the audio data 152 can include pausing and subsequently resuming generation of the audio data 152, adjusting a speed at which the audio generator 150 processes output tokens from the output token buffer 134 to generate the audio data 152, or a combination thereof. Optionally, in some embodiments, the controller 142 sends a generation speed control signal 194 to the audio generator 150 to adjust the generation rate of the audio generator 150, and the audio generator 150 adjusts the generation rate of the audio data 152 based on the generation speed control signal 194.

In an example, the controller 142, based on determining that a first temperature indicated at a first time by the sensor output 122 is greater than a first temperature threshold, sends the generation speed control signal 194 indicating a first value (e.g., 0) to pause generation of the audio data 152 at the audio generator 150. The controller 142, based on determining that a second temperature indicated at a second time by the sensor output 122 is less than or equal to a second temperature threshold, sends the generation speed control signal 194 indicating a second value (e.g., 1) to resume generation of the audio data 152 at the audio generator 150. In some examples, the first temperature threshold is equal to the second temperature threshold. In other examples, the first temperature threshold is higher than the second temperature threshold.

Optionally, in some embodiments, the controller 142 is configured to pause the generation of the audio data 152 for a pre-determined pause duration that is based on the temperature. For example, the controller 142, in response to determining that a temperature indicated by the sensor output 122 is greater than a first threshold, pauses the generation of the audio data 152 for a first pre-determined pause duration. Alternatively, the controller 142, in response to determining that the temperature is less than or equal to the first threshold and greater than a second threshold, pauses the generation of the audio data 152 for a second pre-determined pause duration that is shorter than the first pre-determined pause duration. In some embodiments, the controller 142 adjusts the generation rate of the audio data 152 at the audio generator 150 based on a temperature difference between a temperature indicated by the sensor output 122 and a temperature threshold. For example, the controller 142 selects a pre-determined pause duration corresponding to the temperature difference.

Optionally, in some embodiments, the controller 142 dynamically determines a pause duration based on a count of audio samples corresponding to the audio data 152 stored in the audio buffer 136. For example, the controller 142, based at least in part on determining that a count of audio samples corresponding to the audio data 152 stored in the audio buffer 136 is less than an audio sample count threshold, determines that a pause duration has ended and resumes generation of the audio data 152. In an example, the controller 142 resumes generation of the audio data 152 to prevent a disruption in playout of the audio data 154 if the count of audio samples corresponding to the audio data 152 stored in the audio buffer 136 is too low to prevent a perceptible gap in audio playout.

In some aspects, the controller 142, based on determining that the second temperature is greater than a third temperature threshold, sends the generation speed control signal 194 indicating a value (e.g., 10) to configure the audio generator 150 to generate the audio data 152 at the audio generator 150 at a first generation speed (e.g., process 10 output tokens per second) to reduce a generation rate of the audio data 152. Alternatively, the controller 142, based on determining that the second temperature is less than or equal to the third temperature threshold, sends the generation speed control signal 194 indicating a value (e.g., 100) to configure the audio generator 150 to generate the audio data 152 at the audio generator 150 at a second generation speed (e.g., process 100 output tokens per second) that is greater than the first generation speed. In some embodiments, the second temperature threshold is greater than the third temperature threshold.

In some examples, the controller 142 slows down the generation speed of the audio generator 150 and, if the temperature keeps rising, the controller 142 pauses generation of the audio data 152. Similarly, the controller 142 resumes generation of the audio data 152 when the temperature falls, after a pause duration, or both. If the temperature continues to fall, the controller 142 speeds up the generation speed of the audio generator 150.

In some examples, the controller 142 provides the sensor output 122 to the audio generator 150 and the audio generator 150 performs similar operations described with reference to the controller 142 to adjust the generation rate of the audio data 152 based on the temperature. For example, the audio generator 150 compares the temperature to one or more thresholds and performs corresponding operations to selectively adjust the generation rate of the audio data 152.

In some aspects, selectively reducing a generation rate of the audio data 152 pauses generation of the output data 148. For example, reducing the generation rate of the audio data 152 slows down retrieval and processing of the output tokens from the output token buffer 134 by the audio generator 150. In response to determining that the output token buffer 134 is full (e.g., there is insufficient space available to store additional output tokens), the controller 142 pauses generation of the output data 148 at the LLM 146.

The system 100 thus enables the LLM-based audio generator 140 to control generation of output data (e.g., the output data 148, the audio data 152, or both) by the LLM 146 based on the temperature indicated by the sensor output 122. A technical advantage of controlling the generation of the output data includes reducing the temperature associated with the device 102 when the temperature is higher, and dynamically improving the performance (e.g., response length, generation rate, or both) of the output generation when the temperature is lower.

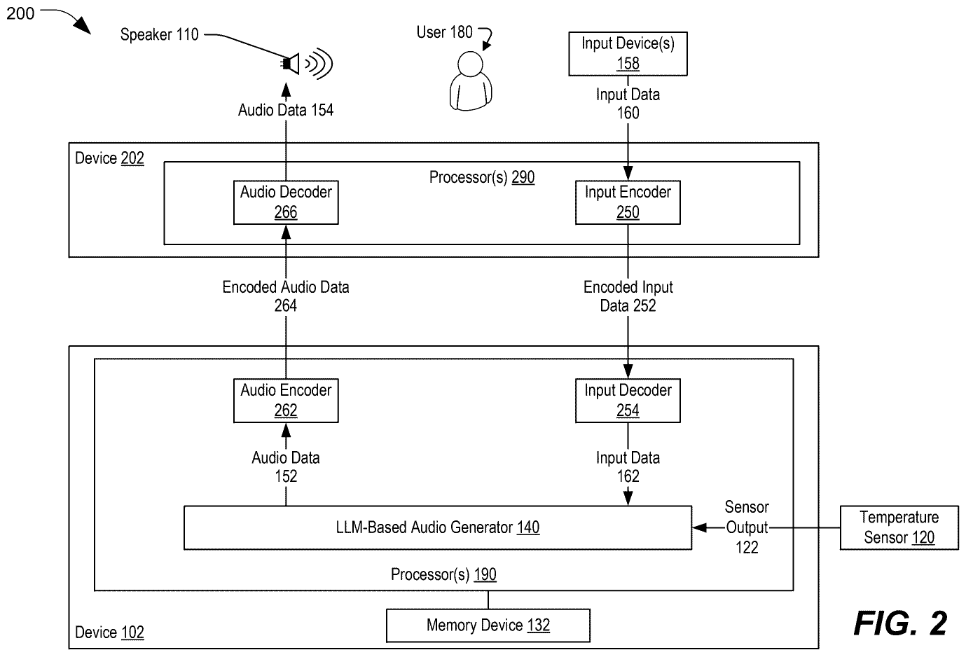

Referring to FIG. 2, a particular illustrative aspect of a system 200 is shown that is configured to perform temperature-based control of an LLM, in accordance with some examples of the present disclosure. The system 200 includes the device 102 configured to be coupled to a device 202.

The device 102 includes the LLM-based audio generator 140 coupled to an input decoder 254, an audio encoder 262, or both. The device 202 includes one or more processors 290 that include an input encoder 250, an audio decoder 266, or both. The input encoder 250 is configured to be coupled to the one or more input devices 158. The audio decoder 266 is configured to be coupled to the speaker 110.

Optionally, in some embodiments, the input encoder 250 obtains the input data 160 from the one or more input devices 158, encodes the input data 160 to generate encoded input data 252, and provides the encoded input data 252 to the device 102. The input decoder 254 receives the encoded input data 252, decodes the encoded input data 252 to generate the input data 162, and provides the input data 162 to the LLM-based audio generator 140. The LLM-based audio generator 140 processes the input data 162 based on the sensor output 122 obtained from the temperature sensor 120 to generate the audio data 152, as described with reference to FIG. 1.

Optionally, in some embodiments, the audio encoder 262 encodes the audio data 152 to generate encoded audio data 264 and provides the encoded audio data 264 to the device 202. The audio decoder 266 decodes the encoded audio data 264 to generate the audio data 154 and provides the audio data 154 to the speaker 110 for playout.

The device 202 thus corresponds to an audio playout device (e.g., a headset, an earbud, a user device, a wearable device, etc.) that offloads some processing to the device 102 (e.g., a computer, a communication device, a network device, etc.). A technical advantage of the system 200 includes conserving resources (e.g., computational cycles, memory, or both) at the audio playout device. In some aspects, the audio playout device can be a relatively light-weight device having fewer resources. Another technical advantage of the system 200 is that the device 102 can be compatible with various types of audio playout devices.

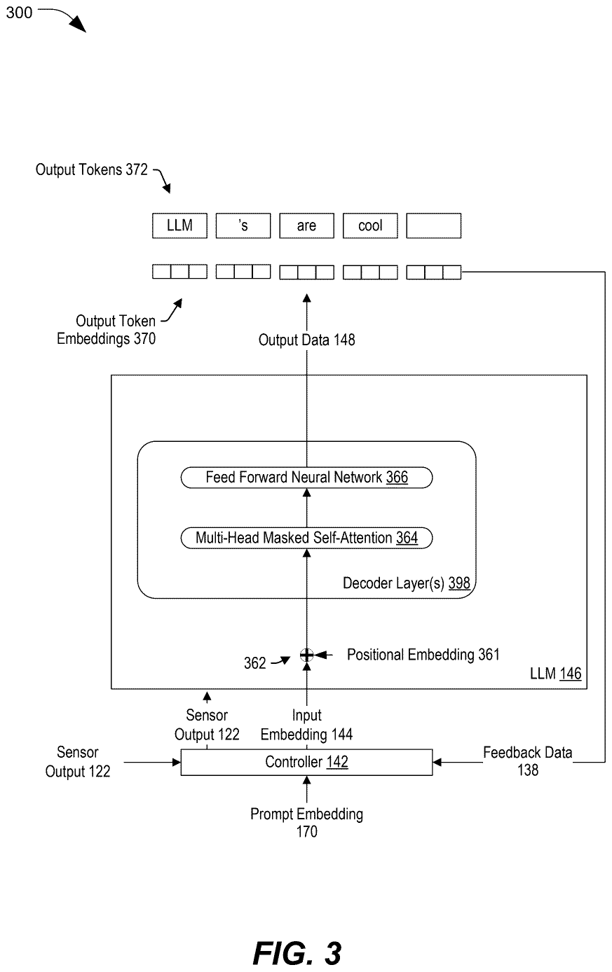

Referring to FIG. 3, a diagram 300 is shown of an illustrative aspect of operation of the controller 142 and the LLM 146 of the LLM-based audio generator 140, in accordance with some examples of the present disclosure.

The LLM 146 includes a combiner 362 coupled to one or more decoder layers 398. Each decoder layer 398 includes a masked attention layer and a feed forward layer. For example, the masked attention layer includes a multi-head masked self-attention 364 (e.g., a masked decoder attention network). The feed forward layer includes a feed forward neural network 366 (e.g., a fully connected feed forward neural network).

The controller 142 generates the input embedding 144 based on the sensor output 122, the prompt embedding 170, the feedback data 138, or a combination thereof, and provides the input embedding 144 to the LLM 146, as described with reference to FIG. 1. Optionally, in some embodiments, the LLM 146 also obtains the sensor output 122 from the controller 142, the temperature sensor 120, or both. In some examples, the LLM 146 performs similar operations described with reference to the controller 142 to adjust the generation rate of the output data 148 based on the temperature, as described with reference to FIG. 1. For example, the LLM 146 compares the temperature to one or more thresholds and performs corresponding operations to selectively adjust the generation rate of the output data 148. To illustrate, the LLM 146 selectively, based on the sensor output 122, pauses or resumes generation of the output data 148 at the LLM 146, adjusts a generation rate of the output data 148 at the LLM 146, adjusts a length of the output data 148 generated by the LLM 146, or a combination thereof.

The combiner 362 combines the input embedding 144 and a positional embedding 361 to generate decoder layer input data of an initial decoder layer 398. A decoder layer 398 processes decoder layer input data to generate decoder layer output data. In a particular aspect, the multi-head masked self-attention 364 masks future positions in the decoder layer input data to the multi-head masked self-attention 364. The multi-head masked self-attention 364 generates Query vectors, Key vectors, and Value vectors from the masked version of the decoder layer input data to the multi-head masked self-attention 364. Each attention head of the multi-head masked self-attention 364 processes a Query vector, a Key vector, and a Value vector to generate an output. The independent outputs of the attention heads of the multi-head masked self-attention 364 are concatenated and linearly transformed to generate an output of the multi-head masked self-attention 364. The output of the multi-head masked self-attention 364 is provided to the feed forward neural network 366 of the decoder layer 398. The output of the feed forward neural network 366 of a particular decoder layer 398 corresponds to decoder layer output data of the particular decoder layer 398.

The one or more decoder layers 398 including a single decoder layer 398 is provided as an illustrative example. In other examples, the one or more decoder layers 398 include multiple decoder layers 398 with the feed forward neural network 366 of each previous decoder layer 398 coupled to the multi-head masked self-attention 364 of a subsequent decoder layer 398, and the feed forward neural network 366 of a last decoder layer 398 coupled to an output of the LLM 146. The decoder layer output data of the last decoder layer 398 corresponds to the output data 148. The output data 148 includes one or more output token embeddings 370 corresponding to one or more respective output tokens 372. In a particular aspect, the LLM-based audio generator 140 stores the output tokens 372 in the output token buffer 134 of FIG. 1.

Referring to FIG. 4, a particular implementation of a method 400 of performing temperature-based control of an LLM is shown, in accordance with some examples of the present disclosure. In a particular aspect, one or more operations of the method 400 may be performed by the prompt generator 164, the prompt encoder 168, the controller 142, the LLM 146, the audio generator 150, the one or more processors 190, the device 102, the system 100 of FIG. 1, the system 200 of FIG. 2, the one or more decoder layers 398, the multi-head masked self-attention 364, the feed forward neural network 366, the combiner 362 of FIG. 3, or a combination thereof.

The method 400 includes, at 402, encoding a prompt to generate an input embedding. For example, the prompt encoder 168 of FIG. 1 encodes the input prompt 166 to generate the prompt embedding 170 and the controller 142 encodes the prompt embedding 170 and optionally the sensor output 122 to generate the input embedding 144, as described with reference to FIG. 1.

The method 400 includes, at 404, decoding the input embedding. For example, the LLM-based audio generator 140 of FIG. 1 uses the LLM 146 to decode the input embedding 144 to generate the output data 148, as described with reference to FIG. 1. The output data 148 includes the output token embeddings 370 corresponding to the output tokens 372, as described with reference to FIG. 3.

The method 400 includes, at 406, adding output tokens to an output token buffer. For example, the LLM-based audio generator 140 of FIG. 1 adds the output tokens 372 to the output token buffer 134, as described with reference to FIG. 3.

The method 400 includes, at 408, determining whether a buffer length is greater than a first buffer length threshold (Bmax). For example, the LLM-based audio generator 140 of FIG. 1 determines whether a count of output tokens stored in the output token buffer 134 is greater than a first token count threshold.

The method 400 includes, at 410, determining whether a temperature is greater than a first temperature threshold (T1) and whether the buffer length is greater than a second buffer length threshold (Bmin). For example, the LLM-based audio generator 140 of FIG. 1 determines whether a first temperature indicated by the sensor output 122 is greater than a first temperature threshold (e.g., 35 degrees Celsius) and whether a count of output tokens stored in the output token buffer 134 is greater than a second token count threshold. The method 400, in response to the LLM-based audio generator 140 determining that the first temperature is less than or equal to the first temperature threshold or that the count of output tokens stored in the output token buffer 134 is less than or equal to the second token count threshold, returns to 404.

In a particular aspect, Bmax corresponds to a target count of output tokens for performing audio generation, whereas Bmin is lower than Bmax and corresponds to a minimum count of output tokens for performing audio generation. If the temperature is less than or equal to T1 and there are fewer than the target count of output tokens to perform audio generation, the LLM-based audio generator 140 continues to generate more output tokens. If there are fewer than the minimum output tokens available in the output token buffer 134 to perform audio generation, the LLM-based audio generator 140 continues to generate more output tokens independently of the temperature (e.g., even if the temperature is above T1).

The method 400 includes, in response to determining that the buffer length is greater than Bmax, at 408, or that the temperature is greater than T1 and that buffer length is greater than Bmin, at 410, performing audio generation, at 412, and determining whether the temperature is less than a second temperature threshold (T2) or whether the temperature is less than a third temperature threshold (T3) and the buffer length is less than Bmin, at 414. For example, the audio generator 150 of FIG. 1 retrieves one or more output tokens from the output token buffer 134 and processes the retrieved output tokens to generate the audio data 152, as described with reference to FIG. 1. The LLM-based audio generator 140 determines whether the first temperature indicated by the sensor output 122 is less than a second temperature threshold (T2) or whether the first temperature is less than a third temperature threshold (T3) and the count of output tokens stored in the output token buffer 134 is less than Bmin. T3 (e.g., 37 degrees Celsius) is greater than T2 (e.g., 35 degrees Celsius).

The method 400 includes determining whether the condition at 414 is false. Simplification of the false condition is as follows, given that T3 is greater than T2:

$$! ( Temp < T 2 ‖ ( Temp < T 3 \&\& Buffer Length < B min ) ) = ! ( Temp < T 2 ) \&\& ! ( Temp < T 3 \&\& Buffer Length < B min ) = Temp >= T 2 \&\& ( ! ( Temp < T 3 ) ‖ ! ( Buffer Length < B min ) ) = Temp >= T 2 \&\& ( Temp >= T 3 ‖ Buffer Length >= B min ) = ( Temp >= T 2 \&\& Temp >= T 3 ) ‖ ( Temp >= T 2 \&\& Buffer Length >= B min ) = ( Temp >= T 3 ) ‖ ( Temp >= T 2 \&\& Buffer Length >= B min )$$

With the simplified condition, the method 400 includes, in response to determining that the temperature is greater than or equal to T3 or that the temperature is greater than or equal to T2 and the count of output tokens stored in the output token buffer 134 is greater than or equal to Bmin, at 414, adding delay, at 416, and then returning to 414. For example, if the first temperature is greater than or equal to T3, the controller 142 determines that the device 102 is intolerably hot and adds a delay to slow down the generation rate of the LLM 146 to reduce the temperature associated with the device 102 independently of a potential impact on audio generation. If the first temperature is greater than or equal to T2 (and less than T3) and the count of output tokens is greater than or equal to Bmin, the controller 142 determines that a disruption in audio generation is less likely and the device 102 has a greater than target temperature, and adds the delay to slow down the generation rate of the LLM 146 to reduce the temperature associated with the device 102. Optionally, in some embodiments, adding the delay corresponds to the controller 142 delaying providing a subsequent input embedding 144 to the LLM 146. In a particular aspect, adding the delay corresponds to the controller 142 sending a generation speed control signal 192 of FIG. 1 to the LLM 146 having a first value at a first time to slow down (e.g., pause or reduce speed) the generation rate of the LLM 146 and sending the generation speed control signal 192 to the LLM 146 having a second value at a second time (e.g., resume or increase speed) to increase the generation rate of the LLM 146, as described with reference to FIG. 1.

Alternatively, the method 400 includes, in response to determining that the temperature is less than T2 or that the temperature is less than T3 and the count of output tokens stored in the output token buffer 134 is less than Bmin, at 414, determining whether the response is complete, at 418. For example, the controller 142, in response to determining that the output data 148 generated by a prior iteration of the LLM 146 includes an end indication (e.g., an end token), determines that the response to the input prompt 166 is complete. Alternatively, the controller 142, in response to determining that the output data 148 generated by a prior iteration of the LLM 146 does not include an end indication, determines that the response to the input prompt 166 is incomplete and the method 400 returns to 404.

The method 400 thus enables a generation rate of the LLM 146 to be slowed down when the temperature indicated by the sensor output 122 is greater than T3 independently of the impact on audio generation or when the temperature indicated by the sensor output 122 is greater than T2 and the delay is less likely to disrupt audio generation. Slowing down the generation rate of the LLM 146 can reduce the temperature associated with the device 102.

Referring to FIG. 5A, a particular implementation of a method 500 of performing the audio generation 412 is shown, in accordance with some examples of the present disclosure. In a particular aspect, one or more operations of the method 500 can be performed by the audio generator 150, the LLM-based audio generator 140, the one or more processors 190, the device 102, the system 100 of FIG. 1, the system 200 of FIG. 2, or a combination thereof.

The method 500 includes, at 510, determining whether the buffer length is greater than Bmin. For example, the audio generator 150 of FIG. 1 determines whether a count of output tokens available in the output token buffer 134 is greater than Bmin. The method 500 ends if the count of output tokens is less than or equal to Bmin.

Alternatively, the method 500 includes, in response to determining that the buffer length is greater than Bmin, at 510, processing one or more output tokens from the buffer to generate audio data, at 520. For example, the audio generator 150 of FIG. 1, in response to determining that the count of output tokens is greater than Bmin, obtains one or more output tokens 372 of FIG. 3 from the output token buffer 134. The audio generator 150 processes the one or more output tokens 372 to generate audio data 152 corresponding to one or more audio samples.

The method 500 includes, at 530, adding the audio data to the audio buffer. For example, the audio generator 150 of FIG. 1 adds the audio data 152 corresponding to the one or more audio samples to the audio buffer 136, as described with reference to FIG. 1. The method 500 returns to 510.

Referring to FIG. 5B, a particular implementation of a method 550 of performing the audio generation 412 is shown, in accordance with some examples of the present disclosure. In a particular aspect, one or more operations of the method 550 can be performed by the audio generator 150, the LLM-based audio generator 140, the one or more processors 190, the device 102, the system 100 of FIG. 1, the system 200 of FIG. 2, or a combination thereof.

The method 550 includes, in response to determining that the buffer length is greater than Bmin, at 510, determining whether a temperature is greater than a temperature threshold (T4), at 512. For example, the audio generator 150 of FIG. 1 determines whether a temperature indicated by the sensor output 122 is greater than T4.

The method 550 includes, in response to determining that the temperature is greater than T4, at 512, adding delay, at 514, and then proceeding to 520. For example, the audio generator 150 adds a delay prior to processing one or more output tokens 372 from the output token buffer 134. Optionally, in some embodiments, adding the delay corresponds to the controller 142 sending a generation speed control signal 194 of FIG. 1 to the audio generator 150 having a first value at a first time to slow down (e.g., to pause or reduce speed) the generation rate of the audio generator 150 and sending the generation speed control signal 194 to the audio generator 150 having a second value at a second time (e.g., to resume or increase speed) to increase the generation rate of the audio generator 150, as described with reference to FIG. 1. Alternatively, the method 550 includes, in response to determining that the temperature is less than or equal to T4, at 512, proceeding to 520.

The method 550 enables slowing down a generation rate of the audio data 152 to reduce a temperature associated with the device 102. To illustrate, the generation rate of the audio data 152 is reduced when the temperature indicated by the sensor output 122 is greater than T4.

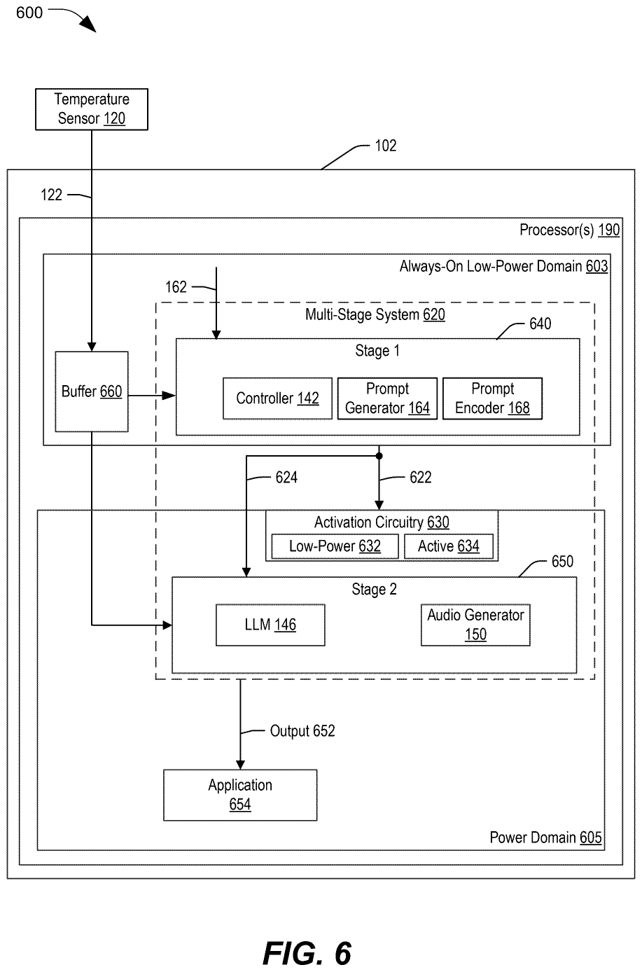

FIG. 6 is a block diagram of an illustrative aspect of a system 600 operable to perform temperature-based control of an LLM, in accordance with some examples of the present disclosure, in which the one or more processors 190 include an always-on power domain 603 and a second power domain 605, such as an on-demand power domain. In some implementations, a first stage 640 of a multi-stage system 620 and a buffer 660 are configured to operate in an always-on mode, and a second stage 650 of the multi-stage system 620 is configured to operate in an on-demand mode.

The always-on power domain 603 includes the buffer 660 and the first stage 640. The first stage 640 includes the controller 142, the prompt generator 164, the prompt encoder 168, or a combination thereof. The buffer 660 is configured to store the sensor output 122, the output data 148, or both, to be accessible for processing by components of the multi-stage system 620. The second power domain 605 includes the second stage 650 of the multi-stage system 620 and also includes activation circuitry 630.

The first stage 640 of the multi-stage system 620 is configured to generate at least one of a wakeup signal 622 or an interrupt 624 to initiate one or more operations at the second stage 650. In an example, the wakeup signal 622 is configured to transition the second power domain 605 from a low-power mode 632 to an active mode 634 to activate one or more components of the second stage 650. In some embodiments, the first stage 640 generates at least one of the wakeup signal 622 or the interrupt 624 based on the controller 142 determining that a temperature indicated by the sensor output 122 is less than or equal to a temperature threshold.

For example, the activation circuitry 630 may include or be coupled to power management circuitry, clock circuitry, head switch or foot switch circuitry, buffer control circuitry, or any combination thereof. The activation circuitry 630 may be configured to initiate powering-on of the second stage 650, such as by selectively applying or raising a voltage of a power supply of the second stage 650, of the second power domain 605, or both. As another example, the activation circuitry 630 may be configured to selectively gate or un-gate a clock signal to the second stage 650, such as to prevent or enable circuit operation without removing a power supply.

Optionally, in some embodiments, an output 652 generated by the second stage 650 of the multi-stage system 620 is provided to an application 654. The application 654 may be configured to process audio input data. To illustrate, the application 654 may correspond to a voice interface application, an integrated assistant application, a vehicle navigation and entertainment application, or a home automation system, as illustrative, non-limiting examples.

By selectively activating the second stage 650 based on a result of processing the sensor output 122 at the first stage 640 of the multi-stage system 620, overall power consumption associated with using the LLM 146, the audio generator 150, or both, may be reduced.

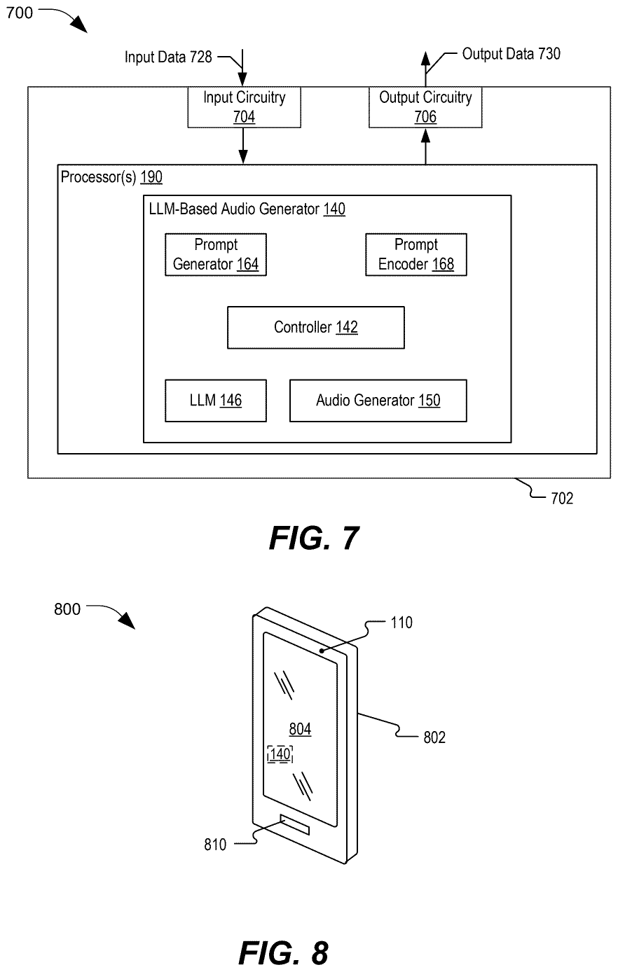

FIG. 7 depicts an implementation 700 of the device 102 as an integrated circuit 702 that includes the one or more processors 190. The one or more processors 190 include at least one component of the LLM-based audio generator 140, such as the controller 142, the LLM 146, the prompt generator 164, the prompt encoder 168, the audio generator 150, or a combination thereof. Optionally, in a particular embodiment, the one or more processors 190 include the audio encoder 262, the input decoder 254 of FIG. 2, or both.

The integrated circuit 702 also includes input circuitry 704, such as one or more bus interfaces, to enable input data 728 to be received for processing. In a particular aspect, the input data 728 includes the input data 160, the input data 162, the input prompt 166, the prompt embedding 170, the sensor output 122, the input embedding 144, the output data 148, the feedback data 138 of FIG. 1, the encoded input data 252 of FIG. 2, or a combination thereof. The integrated circuit 702 also includes output circuitry 706, such as a bus interface, to enable sending of output data 730, such as the output data 148, the audio data 152, the audio data 154 of FIG. 1, the encoded audio data 264 of FIG. 2, or a combination thereof.

The integrated circuit 702 enables implementation of temperature-based control of an LLM as a component in a system that includes a speaker, such as a mobile phone or tablet as depicted in FIG. 8, a headset as depicted in FIG. 9, a wearable electronic device as depicted in FIG. 10, a mixed reality or augmented reality glasses device, as described with reference to FIG. 11, earbuds, as described with reference to FIG. 12, a voice-controlled speaker system as depicted in FIG. 13, a camera as depicted in FIG. 14, a virtual reality, mixed reality, or augmented reality headset as depicted in FIG. 15, or a vehicle as depicted in FIG. 16 or FIG. 17.

FIG. 8 depicts an implementation 800 in which the device 102 includes a mobile device 802, such as a phone or a tablet, as illustrative, non-limiting examples. The mobile device 802 includes the speaker 110, a microphone 810, and a display screen 804. The one or more processors 190, including at least one component of the LLM-based audio generator 140, are integrated in the mobile device 802. Optionally, in some embodiments, the one or more processors 190 include the audio encoder 262, the input decoder 254, or both. The LLM-based audio generator 140 is illustrated using dashed lines to indicate an internal component that is not generally visible to a user of the mobile device 802.

In a particular example, the prompt generator 164 generates the input prompt 166 of FIG. 1 and performs one or more operations at the mobile device 802, such as to launch a graphical user interface or otherwise display other information associated with the input prompt 166 at the display screen 804 (e.g., via an integrated “smart assistant” application). To illustrate, the prompt generator 164 generates the input prompt 166 based on user voice activity detected in an audio signal received via the microphone 810, based on encoded input data 252 received from a second device (e.g., the device 202 of FIG. 2), or both.

The LLM-based audio generator 140 processes the input prompt 166 to generate the audio data 152. The mobile device 802 generates the audio data 154 of FIG. 1, the encoded audio data 264 of FIG. 2, or both, based on the audio data 152. In a particular aspect, the audio data 154 is provided to the speaker 110, the encoded audio data 264 is provided to a second device (e.g., the device 202 of FIG. 2), or both. In a particular aspect, the one or more processors 190 include a speech-to-text engine that processes the output data 148, the audio data 152, the audio data 154, or a combination thereof, to generate response text which is displayed at the display screen 804.

FIG. 9 depicts an implementation 900 in which a headset device 902 includes the device 102 or the device 202 of FIG. 1 or 2. The headset device 902 includes the speaker 110 and the microphone 810.

Optionally, in some embodiments, the one or more processors 190, including at least one component of the LLM-based audio generator 140, are integrated in the headset device 902. In a particular example, the prompt generator 164 operates to detect the input data 160 and process the input data 160 to generate the audio data 154 which is played out via the speaker 110.

Optionally, in some embodiments, the one or more processors 290, including the audio decoder 266, the input encoder 250, or both, are integrated in the headset device 902. In a particular example, the input encoder 250 operates to detect the input data 160, which is then processed to generate the encoded input data 252 of FIG. 2 that is transmitted to a second device (not shown) such as the device 102 for further processing. The audio decoder 266 receives the encoded audio data 264 from the device 102 and provides the audio data 154 to the speaker 110 for playout, as described with reference to FIG. 2.

FIG. 10 depicts an implementation 1000 in which the device 102 includes a wearable electronic device 1002, illustrated as a “smart watch.” The wearable electronic device 1002 includes the speaker 110, the microphone 810, and a display screen 1004. The one or more processors 190, including at least one component of the LLM-based audio generator 140, are integrated in the wearable electronic device 1002. Optionally, in some embodiments, the one or more processors 190 include the audio encoder 262, the input decoder 254, or both.

In a particular example, the prompt generator 164 generates the input prompt 166 of FIG. 1 and performs one or more operations at the wearable electronic device 1002, such as to launch a graphical user interface or otherwise display other information associated with the input prompt 166 at the display screen 1004 of the wearable electronic device 1002. To illustrate, the prompt generator 164 generates the input prompt 166 based on user voice activity detected in an audio signal received via the microphone 810, based on encoded input data 252 received from a second device (e.g., the device 202 of FIG. 2), or both.

The LLM-based audio generator 140 processes the input prompt 166 to generate the audio data 152. The wearable electronic device 1002 generates the audio data 154 of FIG. 1, the encoded audio data 264 of FIG. 2, or both, based on the audio data 152. In a particular aspect, the audio data 154 is provided to the speaker 110, the encoded audio data 264 is provided to a second device (e.g., the device 202 of FIG. 2), or both. In a particular aspect, the one or more processors 190 include a speech-to-text engine that processes the output data 148, the audio data 152, the audio data 154, or a combination thereof, to generate response text which is displayed at the display screen 1004.

In a particular example, the wearable electronic device 1002 includes a haptic device that provides a haptic notification (e.g., vibrates) in response to detection of the input data 160, display of the response text, or both. For example, the haptic notification can cause a user to look at the wearable electronic device 1002 to see a displayed notification indicating detection of the input data 160, the response text, or both. The wearable electronic device 1002 can thus alert a user with a hearing impairment or a user wearing a headset that the input data 160 is detected, that the response text is displayed, or both.

FIG. 11 depicts an implementation 1100 in which the device 102 includes a portable electronic device that corresponds to augmented reality or mixed reality glasses 1102. The glasses 1102 include a holographic projection unit 1104 configured to project visual data onto a surface of a lens 1106 or to reflect the visual data off of a surface of the lens 1106 and onto the wearer's retina. At least one component of the LLM-based audio generator 140, the audio encoder 262, the input decoder 254, the audio decoder 266, the input encoder 250, the speaker 110, the microphone 810, or a combination thereof, are integrated into the glasses 1102.

The LLM-based audio generator 140 may function to perform temperature-based control of the LLM 146 to generate the audio data 154. In a particular example, the prompt generator 164 operates to detect the input data 160 and process the input data 160 to generate the audio data 154 which is played out via the speaker 110.

In a particular example, the holographic projection unit 1104 includes the input encoder 250 that operates to detect the input data 160, which is then processed to generate the encoded input data 252 of FIG. 2 that is transmitted to a second device (not shown) such as the device 102 for further processing. In a particular example, the holographic projection unit 1104 includes the audio decoder 266 that receives the encoded audio data 264 from the device 102 and provides the audio data 154 to the speaker 110 for playout, as described with reference to FIG. 2.

In a particular example, the holographic projection unit 1104 is configured to display a notification indicating user speech detected in an audio signal obtained from the microphone 810. In a particular example, the holographic projection unit 1104 is configured to display a notification indicating the input data 160, the input prompt 166, a response text corresponding to the audio data 154, or a combination thereof. For example, the notification can be superimposed on the user's field of view. To illustrate, the sound corresponding to the audio data 154 may be perceived by the user as emanating from the direction of the notification.

FIG. 12 depicts an implementation 1200 in which the device 102 includes a portable electronic device that corresponds to a pair of earbuds 1206 that includes a first earbud 1202 and a second earbud 1204. Although earbuds are described, it should be understood that the present technology can be applied to other in-ear or over-ear playback devices.

The first earbud 1202 includes a first microphone 1220, such as a high signal-to-noise microphone positioned to capture the voice of a wearer of the first earbud 1202, an array of one or more other microphones configured to detect ambient sounds and spatially distributed to support beamforming, illustrated as microphones 1222A, 1222B, and 1222C, an “inner” microphone 1224 proximate to the wearer's ear canal (e.g., to assist with active noise cancelling), and a self-speech microphone 1226, such as a bone conduction microphone configured to convert sound vibrations of the wearer's ear bone or skull into an audio signal.

In a particular implementation, the first microphone 1220 corresponds to the microphone 810, and audio signals generated by the microphones 1220 and 1222A, 1222B, and 1222C are provided to the LLM-based audio generator 140, the input encoder 250 of FIG. 2, or both. The LLM-based audio generator 140 may function to generate the audio data 152, the encoded input data 252, or both, based on the audio signals. In some implementations, the LLM-based audio generator 140, the input encoder 250, or both, may further be configured to process audio signals from one or more other microphones of the first earbud 1202, such as the inner microphone 1224, the self-speech microphone 1226, or both.

In a particular aspect, the speaker 1230 corresponds to the speaker 110. Optionally, in some embodiments, the one or more processors 190, including at least one component of the LLM-based audio generator 140, are integrated in the first earbud 1202. In a particular example, the prompt generator 164 operates to detect the input data 160 and process the input data 160 to generate the audio data 154 which is played out via the speaker 1230.

Optionally, in some embodiments, the one or more processors 290, including the audio decoder 266, the input encoder 250, or both, are integrated in the first earbud 1202. In a particular example, the input encoder 250 operates to detect the input data 160, which is then processed to generate the encoded input data 252 of FIG. 2 that is transmitted to a second device (not shown) such as the device 102 for further processing. The audio decoder 266 receives the encoded audio data 264 from the device 102 and provides the audio data 154 to the speaker 1230 for playout, as described with reference to FIG. 2.

The second earbud 1204 can be configured in a substantially similar manner as the first earbud 1202. In some implementations, the LLM-based audio generator 140, the input encoder 250, or both, of the first earbud 1202 are also configured to receive one or more audio signals generated by one or more microphones of the second earbud 1204, such as via wireless transmission between the earbuds 1202, 1204, or via wired transmission in implementations in which the earbuds 1202, 1204 are coupled via a transmission line. In other implementations, the second earbud 1204 also includes an LLM-based audio generator 140, a input encoder 250, or both, enabling techniques described herein to be performed by a user wearing a single one of either of the earbuds 1202, 1204.

In some implementations, the earbuds 1202, 1204 are configured to automatically switch between various operating modes, such as a passthrough mode in which ambient sound is played via the speaker 1230, a playback mode in which non-ambient sound (e.g., streaming audio corresponding to a phone conversation, media playback, video game, etc.) is played back through the speaker 1230, and an audio zoom mode or beamforming mode in which one or more ambient sounds are emphasized and/or other ambient sounds are suppressed for playback at the speaker 1230. In other implementations, the earbuds 1202, 1204 may support fewer modes or may support one or more other modes in place of, or in addition to, the described modes.

In an illustrative example, the earbuds 1202, 1204 can automatically transition from the playback mode to the passthrough mode in response to detecting the wearer's voice, and may automatically transition back to the playback mode after the wearer has ceased speaking. In some examples, the earbuds 1202, 1204 can operate in two or more of the modes concurrently, such as by performing audio zoom on a particular ambient sound (e.g., a dog barking) and playing out the audio zoomed sound superimposed on the sound being played out while the wearer is listening to music (which can be reduced in volume while the audio zoomed sound is being played). In this example, the wearer can be alerted to the ambient sound associated with the audio event without halting playback of the music.

FIG. 13 is an implementation 1300 in which the device 102 includes a wireless speaker and voice activated device 1302. The wireless speaker and voice activated device 1302 can have wireless network connectivity and is configured to execute an assistant operation. The one or more processors 190 including at least one component of the LLM-based audio generator 140, the speaker 110, the microphone 810, or a combination thereof, are included in the wireless speaker and voice activated device 1302. The wireless speaker and voice activated device 1302 also includes the speaker 110.

During operation, in response to receiving a verbal command identified as user speech, the wireless speaker and voice activated device 1302 can execute assistant operations, such as via execution of a voice activation system (e.g., an integrated assistant application). The assistant operations can include adjusting a temperature, playing music, turning on lights, etc. For example, the assistant operations are performed responsive to receiving a command after a keyword or key phrase (e.g., “hello assistant”). In a particular example, the prompt generator 164 operates to detect the input data 160 and process the input data 160 to generate the audio data 154 which is played out via the speaker 110.

FIG. 14 depicts an implementation 1400 in which the device 102 includes a portable electronic device that corresponds to a camera device 1402. At least one component of the LLM-based audio generator 140, the speaker 110, the input encoder 250, the input decoder 254, the audio encoder 262, the audio decoder 266, the microphone 810, or a combination thereof, are included in the camera device 1402.

During operation, in response to receiving a verbal command identified as user speech, the camera device 1402 can execute operations responsive to spoken user commands, such as to adjust image or video capture settings, image or video playback settings, or image or video capture instructions, as illustrative examples. In a particular example, the prompt generator 164 operates to detect the input data 160 and process the input data 160 to generate the audio data 154 which is played out via the speaker 110.

FIG. 15 depicts an implementation 1500 in which the device 102 includes a portable electronic device that corresponds to a virtual reality, mixed reality, or augmented reality headset 1502. At least one component of the LLM-based audio generator 140, the speaker 110, the microphone 810, or a combination thereof, are integrated into the headset 1502.

User voice activity detection can be performed based on audio signals received from the microphone 810 of the headset 1502. A visual interface device is positioned in front of the user's eyes to enable display of augmented reality, mixed reality, or virtual reality images or scenes to the user while the headset 1502 is worn. In a particular example, the visual interface device is configured to display a notification indicating user speech detected in the audio signal. In a particular example, the prompt generator 164 operates to detect the input data 160 and process the input data 160 to generate the audio data 154 which is played out via the speaker 110.

FIG. 16 depicts an implementation 1600 in which the device 102 corresponds to, or is integrated within, a vehicle 1602, illustrated as a manned or unmanned aerial device (e.g., a package delivery drone). At least one component of the LLM-based audio generator 140, the speaker 110, the microphone 810, or a combination thereof, are integrated into the vehicle 1602. User voice activity detection can be performed based on audio signals received from the microphone 810 of the vehicle 1602, such as for delivery instructions from an authorized user of the vehicle 1602. In a particular example, the prompt generator 164 operates to detect the input data 160 and process the input data 160 to generate the audio data 154 which is played out via the speaker 110.

FIG. 17 depicts another implementation 1700 in which the device 102 corresponds to, or is integrated within, a vehicle 1702, illustrated as a car. The vehicle 1702 includes the one or more processors 190 including at least one component of the LLM-based audio generator 140. The vehicle 1702 also includes the speaker 110, one or more microphones 810, or a combination thereof. In an example, a microphone 810 is positioned to capture utterances of an operator of the vehicle 1702. User voice activity detection can be performed based on audio signals received from the microphone 810 of the vehicle 1702. In some implementations, user voice activity detection can be performed based on an audio signal received from interior microphones (e.g., the microphone 810), such as for a voice command from an authorized passenger. For example, the user voice activity detection can be used to detect a voice command from an operator of the vehicle 1702 (e.g., from a parent to set a volume to 5 or to set a destination for a self-driving vehicle) and to disregard the voice of another passenger (e.g., a voice command from a child to set the volume to 10 or other passengers discussing another location). In some implementations, user voice activity detection can be performed based on an audio signal received from external microphones (e.g., the microphone 810), such as an authorized user of the vehicle. In a particular implementation, in response to receiving a verbal command identified as user speech, a voice activation system initiates one or more operations of the vehicle 1702 based on one or more keywords (e.g., “unlock,” “start engine,” “play music,” “display weather forecast,” or another voice command) detected in a microphone signal, such as by providing feedback or information via a display 1720 or one or more speakers (e.g., the speaker 110). In a particular example, the prompt generator 164 operates to detect the input data 160 and process the input data 160 to generate the audio data 154 which is played out via the speaker 110.

Referring to FIG. 18, a particular implementation of a method 1800 of performing temperature-based control of an LLM is shown. In a particular aspect, one or more operations of the method 1800 are performed by at least one of the controller 142, the LLM 146, the LLM-based audio generator 140, the one or more processors 190, the device 102, the system 100 of FIG. 1, or a combination thereof.

At 1802, the method 1800 includes obtaining, from a temperature sensor, a sensor output indicating a temperature associated with a device. For example, the controller 142 of FIG. 1 obtains the sensor output 122 from the temperature sensor 120, as described with reference to FIG. 1. The sensor output 122 indicates a temperature associated with the device 102.

At 1804, the method 1800 includes, based on the temperature and first output data of a large language model (LLM), controlling generation of second output data by the LLM. For example, the LLM-based audio generator 140, based on the temperature and the feedback data 138 of the LLM 146, controls generation of the output data 148, the audio data 152, or both, by the LLM 146, as described with reference to FIG. 1. In some aspects, the controller 142 generates the input embedding 144 based on the feedback data 138 and the sensor output 122, and the LLM 146 processes the input embedding 144 to generate the output data 148 having a length that is based on the temperature. In some aspects, the controller 142 selectively adjusts a generation rate of the LLM 146 based on the temperature. In some aspects, the controller 142, the audio generator 150, or both, selectively adjust a generation rate of the audio generator 150 based on the temperature.

The method 1800 enables the LLM-based audio generator 140 to control generation of output data (e.g., the output data 148, the audio data 152, or both) based on the temperature indicated by the sensor output 122. A technical advantage of controlling the generation of the output data includes reducing the temperature associated with the device 102 when the temperature is higher, and dynamically improving the performance (e.g., response length, generation rate, or both) of the output generation when the temperature is lower.

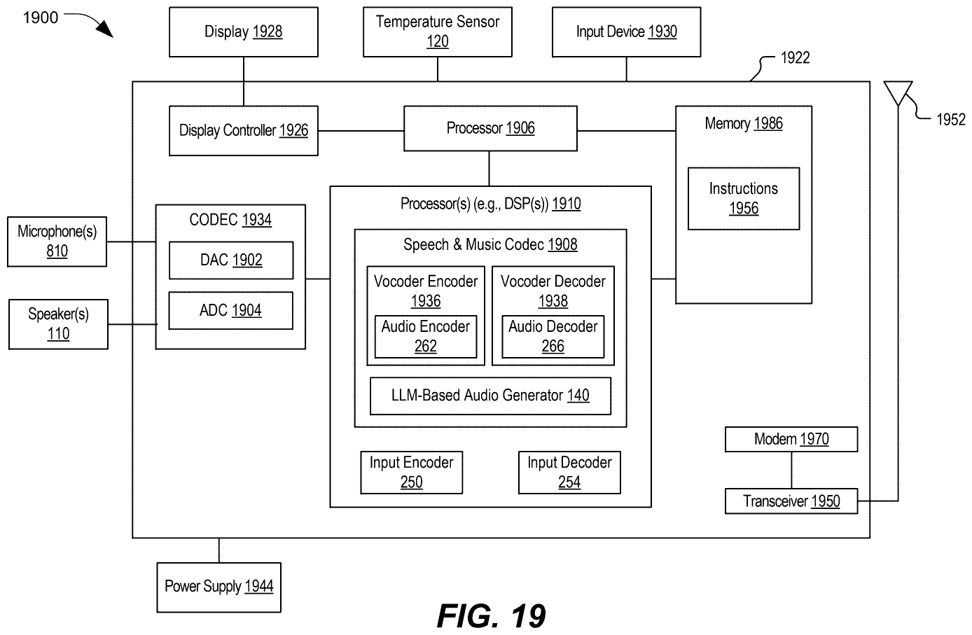

The method 1800 of FIG. 18 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1800 of FIG. 18 may be performed by a processor that executes instructions, such as described with reference to FIG. 19.

Referring to FIG. 19, a block diagram of a particular illustrative implementation of a device is depicted and generally designated 1900. In various implementations, the device 1900 may have more or fewer components than illustrated in FIG. 19. In an illustrative implementation, the device 1900 may correspond to the device 102, the device 202, or both. In an illustrative implementation, the device 1900 may perform one or more operations described with reference to FIGS. 1-18.

In a particular implementation, the device 1900 includes a processor 1906 (e.g., a CPU). The device 1900 may include one or more additional processors 1910 (e.g., one or more DSPs). In a particular aspect, the one or more processors 190 of FIG. 1 correspond to the processor 1906, the processors 1910, or a combination thereof. In a particular aspect, the one or more processors 290 of FIG. 2 correspond to the processor 1906, the processors 1910, or a combination thereof. The processors 1910 may include a speech and music coder-decoder (CODEC) 1908 that includes a voice coder (“vocoder”) encoder 1936, a vocoder decoder 1938, the LLM-based audio generator 140, or a combination thereof. In a particular aspect, the vocoder encoder 1936 includes the audio encoder 262, the vocoder decoder 1938 includes the audio decoder 266, or both. In a particular aspect, the processors 1910 include the input encoder 250, the input decoder 254, or both.

The device 1900 may include a memory 1986 and a CODEC 1934. The memory 1986 may include instructions 1956, that are executable by the one or more additional processors 1910 (or the processor 1906) to implement the functionality described with reference to at least one component of the LLM-based audio generator 140, the audio encoder 262, the audio decoder 266, the input encoder 250, the input decoder 254, or a combination thereof. The device 1900 may include a modem 1970 coupled, via a transceiver 1950, to an antenna 1952. The modem 1970 is configured to modulate input data (e.g., the audio data 152, the encoded audio data 264, or both) to generate modulated data. Each of the transceiver 1950 and the antenna 1952 is configured to send the modulated data. In a particular aspect, the memory 1986 includes the memory device 132.

The device 1900 may include a display 1928 coupled to a display controller 1926. One or more speakers 110 and one or more microphones 810 may be coupled to the CODEC 1934. The CODEC 1934 may include a digital-to-analog converter (DAC) 1902, an analog-to-digital converter (ADC) 1904, or both. In a particular implementation, the CODEC 1934 may receive analog signals from the microphone 810, convert the analog signals to digital signals using the analog-to-digital converter 1904, and provide the digital signals to the speech and music codec 1908. The speech and music codec 1908 may process the digital signals, and the digital signals may further be processed by the LLM-based audio generator 140, the input encoder 250, or both. In a particular implementation, the LLM-based audio generator 140 or the audio decoder 266 may generate digital signals and the speech and music codec 1908 may provide the digital signals to the CODEC 1934. The CODEC 1934 may convert the digital signals to analog signals using the digital-to-analog converter 1902 and may provide the analog signals to the speaker(s) 110.

In a particular implementation, the device 1900 may be included in a system-in-package or system-on-chip device 1922. In a particular implementation, the memory 1986, the processor 1906, the processors 1910, the display controller 1926, the CODEC 1934, and the modem 1970 are included in the system-in-package or system-on-chip device 1922. In a particular implementation, the temperature sensor 120, an input device 1930, and a power supply 1944 are coupled to the system-in-package or the system-on-chip device 1922. Moreover, in a particular implementation, as illustrated in FIG. 19, the display 1928, the input device 1930, the temperature sensor 120, the speaker(s) 110, the microphone(s) 810, the antenna 1952, and the power supply 1944 are external to the system-in-package or the system-on-chip device 1922. In a particular implementation, each of the display 1928, the input device 1930, the temperature sensor 120, the speaker(s) 110, the microphone(s) 810, the antenna 1952, and the power supply 1944 may be coupled to a component of the system-in-package or the system-on-chip device 1922, such as an interface or a controller. In a particular aspect, the input device 1930, the microphone(s) 810, or a combination thereof, correspond to the one or more input devices 158 of FIG. 1.

The device 1900 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining a sensor output from a temperature sensor, the sensor output indicating a temperature associated with a device. For example, the means for obtaining can correspond to the controller 142, the audio generator 150, the LLM-based audio generator 140, the one or more processors 190, the device 102, the system 100, the processor 1906, the processor(s) 1910, the antenna 1952, the transceiver 1950, the modem 1970, one or more other circuits or components configured to obtain the sensor output, or any combination thereof.

The apparatus further includes means for controlling generation of second output data by the LLM, the generation of the second output data controlled based on the temperature and first output data of a large language model (LLM). For example, the means for controlling can correspond to the controller 142, the audio generator 150, the LLM-based audio generator 140, the one or more processors 190, the device 102, the system 100, the processor 1906, the processor(s) 1910, one or more other circuits or components configured to control generation of the second output data, or any combination thereof.

In some implementations, a non-transitory computer-readable medium (e.g., a computer-readable storage device, such as the memory 1986) includes instructions (e.g., the instructions 1956) that, when executed by one or more processors (e.g., the one or more processors 1910 or the processor 1906), cause the one or more processors to obtain, from a temperature sensor (e.g., the temperature sensor 120), a sensor output (e.g., the sensor output 122) indicating a temperature associated with a device (e.g., the device 102). The instructions further cause the one or more processors to, based on the temperature and first output data (e.g., the feedback data 138) of a large language model (LLM) (e.g., the LLM 146), control generation of second output data (e.g., the output data 148, the audio data 152, or both) by the LLM.

Particular aspects of the disclosure are described below in sets of interrelated Examples:

According to Example 1, a device includes a memory device configured to store output data of a large language model (LLM); and one or more processors configured to: obtain, from a temperature sensor, a first sensor output indicating a first temperature associated with the device; and based on the first temperature and first output data of the LLM, control generation of second output data by the LLM.

Example 2 includes the device of Example 1, wherein the temperature sensor is coupled to or included in one or more components of the device.

Example 3 includes the device of Example 2, wherein the one or more components of the device include at least one of a processor, a transistor junction of a processor, an audio codec, a modem, or a memory component.

Example 4 includes the device of any of Examples 1 to 3, wherein the temperature sensor is configured to generate the first sensor output based at least in part on detection of a temperature coefficient of a resistive component, voltage characteristics of a diode, current characteristics of the diode, voltage characteristics of a transistor junction, current characteristics of the transistor junction, oscillation frequency of an oscillator, thermal noise of a resistor, material expansion or contraction, temperature dependent dielectric properties, or magnetic field measurements.

Example 5 includes the device of any of Examples 1 to 4, wherein the first output data is provided as feedback data to the LLM, and wherein the second output data is generated at the LLM based on the first output data.

Example 6 includes the device of any of Examples 1 to 5, wherein the LLM is configured to generate the second output data based on the first output data, and wherein the one or more processors are configured to selectively, based on the first temperature, pause the generation of the second output data at the LLM.

Example 7 includes the device of any of Examples 1 to 6, wherein the LLM is configured to generate the second output data based on the first output data, and wherein the one or more processors are configured to, based on a determination that the first temperature is higher than a first temperature threshold, pause the generation of the second output data at the LLM.

Example 8 includes the device of Example 7, wherein the one or more processors are configured to obtain, from the temperature sensor, a second sensor output indicating a second temperature associated with the device; and resume the generation of the second output data at the LLM based on a determination that the second temperature is lower than a second temperature threshold.

Example 9 includes the device of Example 8, wherein the one or more processors are configured to resume the generation of the second output data further based on a determination that a count of output tokens of the output data stored in the memory device is less than a token count threshold.

Example 10 includes the device of Example 7, wherein the one or more processors are configured to pause the generation of the second output data for a duration that is based on the first temperature.

Example 11 includes the device of any of Examples 1 to 10, wherein the LLM is configured to generate the second output data based on the first output data, and wherein the one or more processors are configured to selectively, based on a difference between the first temperature and a temperature threshold, adjust a generation rate of the second output data at the LLM.

Example 12 includes the device of any of Examples 1 to 11, wherein the one or more processors are configured to generate audio data based on the first output data, the second output data, or both.

Example 13 includes the device of Example 12, wherein the one or more processors are configured to selectively, based on the first temperature, update a generation rate of the audio data.

Example 14 includes the device of Example 12 or Example 13, wherein the one or more processors are configured to selectively, based on the first temperature, reduce a generation rate of the audio data based on the first output data to pause the generation of the second output data.

Example 15 includes the device of any of Examples 12 to 14 and further includes a speaker coupled to the one or more processors and configured to output audio corresponding to the audio data.

Example 16 includes the device of any of Examples 12 to 15, wherein the one or more processors are configured to encode the audio data to generate encoded audio data; and provide the encoded audio data to another device.

Example 17 includes the device of Example 16, wherein the memory device and the one or more processors are integrated in a communication device, and wherein the other device includes a wearable device.

Example 18 includes the device of any of Examples 12 to 17 and further includes a modem configured to modulate the audio data to generate modulated data.

Example 19 includes the device of Example 18 and further includes an antenna configured to send the modulated data.

Example 20 includes the device of any of Examples 1 to 19, wherein the LLM is configured to generate the second output data based on the first output data, and wherein the one or more processors are configured to configure the LLM to generate the second output data having a length that is based on the first temperature.

Example 21 includes the device of any of Examples 1 to 20, wherein the one or more processors are configured to generate an input embedding based on the first output data and the first temperature, the LLM configured to process the input embedding to generate the second output data.

Example 22 includes the device of any of Examples 1 to 21, wherein the one or more processors are configured to obtain, from a prompt encoder, a prompt embedding of an input prompt, the LLM configured to generate the first output data based on the prompt embedding.

Example 23 includes the device of Example 22 and further includes an input device coupled to the one or more processors and configured to generate input data, wherein the input prompt is based on the input data.

Example 24 includes the device of Example 23, wherein the input device includes at least one of a microphone, a keyboard, or a camera.

Example 25 includes the device of any of Examples 1 to 24, wherein the one or more processors and the memory device are integrated into at least one of an integrated circuit, a mobile device, a headset, a wearable electronic device, an extended reality device, an earbud, a voice-controlled speaker system, a communication device, a portable device, a camera, or a vehicle.

According to Example 26, a method includes obtaining, from a temperature sensor, a first sensor output indicating a first temperature associated with a first device; and based on the first temperature and first output data of a large language model (LLM), controlling generation of second output data by the LLM.

Example 27 includes the method of Example 26, wherein the temperature sensor is coupled to or included in one or more components of the device.

Example 28 includes the method of Example 27, wherein the one or more components of the device include at least one of a processor, a transistor junction of a processor, an audio codec, a modem, or a memory component.

Example 29 includes the method of any of Examples 26 to 28, wherein the temperature sensor is configured to generate the first sensor output based at least in part on detection of a temperature coefficient of a resistive component, voltage characteristics of a diode, current characteristics of the diode, voltage characteristics of a transistor junction, current characteristics of the transistor junction, oscillation frequency of an oscillator, thermal noise of a resistor, material expansion or contraction, temperature dependent dielectric properties, or magnetic field measurements.

Example 30 includes the method of any of Examples 26 to 29, wherein the first output data is provided as feedback data to the LLM, and wherein the second output data is generated at the LLM based on the first output data.

Example 31 includes the method of any of Examples 26 to 30, wherein controlling the generation of the second output data includes selectively, based on the first temperature, pausing the generation of the second output data at the LLM, wherein the LLM is configured to generate the second output data based on the first output data.

Example 32 includes the method of any of Examples 26 to 31, wherein controlling the generation of the second output data includes, based on determining that the first temperature is higher than a first temperature threshold, pausing the generation of the second output data at the LLM, wherein the LLM is configured to generate the second output data based on the first output data.

Example 33 includes the method of Example 32, further includes obtaining, from the temperature sensor, a second sensor output indicating a second temperature associated with the first device; and resuming the generation of the second output data at the LLM based on determining that the second temperature is lower than a second temperature threshold.

Example 34 includes the method of Example 33, wherein the generation of the second output data is resumed further based on determining that a count of output tokens of output data of the LLM stored in a memory device is less than a token count threshold.

Example 35 includes the method of Example 32, wherein the generation of the second output data is paused for a duration that is based on the first temperature.

Example 36 includes the method of any of Examples 26 to 35, wherein controlling the generation of the second output data includes selectively, based on a difference between the first temperature and a temperature threshold, adjusting a generation rate of the second output data at the LLM, wherein the LLM is configured to generate the second output data based on the first output data.

Example 37 includes the method of any of Examples 26 to 36 and further includes generating audio data based on first output data, the second output data, or both.

Example 38 includes the method of Example 37 and further includes selectively, based on the first temperature, updating a generation rate of the audio data.

Example 39 includes the method of Example 37 or Example 38, and further includes selectively, based on the first temperature, reducing a generation rate of the audio data based on the first output data to pause the generation of the second output data.

Example 40 includes the method of any of Examples 37 to 39 and further includes providing the audio data to a speaker.

Example 41 includes the method of any of Examples 37 to 40, further includes encoding the audio data to generate encoded audio data; and providing the encoded audio data to a second device.

Example 42 includes the method of Example 41, wherein the first device includes a communication device, and wherein the second device includes a wearable device.

Example 43 includes the method of any of Examples 37 to 42 and further includes using a modem to modulate the audio data to generate modulated data.

Example 44 includes the method of Example 43 and further includes sending, via an antenna, the modulated data.

Example 45 includes the method of any of Examples 26 to 44, wherein controlling the generation of the second output data includes configuring the LLM to generate the second output data having a length that is based on the first temperature, wherein the LLM is configured to generate the second output data based on the first output data.

Example 46 includes the method of any of Examples 26 to 45 and further includes generating an input embedding based on the first output data and the first temperature, the LLM configured to process the input embedding to generate the second output data.

Example 47 includes the method of any of Examples 26 to 46 and further includes obtaining, from a prompt encoder, a prompt embedding of an input prompt, the LLM configured to generate the first output data based on the prompt embedding.

Example 48 includes the method of Example 47 and further includes obtaining input data from an input device, wherein the input prompt is based on the input data.

Example 49 includes the method of Example 48, wherein the input device includes at least one of a microphone, a keyboard, or a camera.

Example 50 includes the method of any of Examples 26 to 49, wherein the first device includes at least one of an integrated circuit, a mobile device, a headset, a wearable electronic device, an extended reality device, an earbud, a voice-controlled speaker system, a communication device, a portable device, a camera, or a vehicle.

According to Example 51, a non-transitory computer-readable medium stores instructions that, when executed by one or more processors, cause the one or more processors to obtain, from a temperature sensor, a sensor output indicating a temperature associated with a device; and based on the temperature and first output data of a large language model (LLM), control generation of second output data by the LLM.

According to Example 52, an apparatus includes means for obtaining a sensor output from a temperature sensor, the sensor output indicating a temperature associated with a device; and means for controlling generation of second output data by the LLM, the generation of the second output data controlled based on the temperature and first output data of a large language model (LLM).

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory device configured to store output data of a large language model (LLM); and
one or more processors configured to:
obtain, from a temperature sensor, a first sensor output indicating a first temperature associated with the device; and
based on the first temperature and first output data of the LLM, control generation of second output data by the LLM.

2. The device of claim 1, wherein the temperature sensor is coupled to or included in one or more components of the device.

3. The device of claim 2, wherein the one or more components of the device include at least one of a processor, a transistor junction of a processor, an audio codec, a modem, or a memory component.

4. The device of claim 1, wherein the temperature sensor is configured to generate the first sensor output based at least in part on detection of a temperature coefficient of a resistive component, voltage characteristics of a diode, current characteristics of the diode, voltage characteristics of a transistor junction, current characteristics of the transistor junction, oscillation frequency of an oscillator, thermal noise of a resistor, material expansion or contraction, temperature dependent dielectric properties, or magnetic field measurements.

5. The device of claim 1, wherein the first output data is provided as feedback data to the LLM, and wherein the second output data is generated at the LLM based on the first output data.

6. The device of claim 1, wherein the LLM is configured to generate the second output data based on the first output data, and wherein the one or more processors are configured to selectively, based on the first temperature, pause the generation of the second output data at the LLM.

7. The device of claim 1, wherein the LLM is configured to generate the second output data based on the first output data, and wherein the one or more processors are configured to, based on a determination that the first temperature is higher than a first temperature threshold, pause the generation of the second output data at the LLM.

8. The device of claim 7, wherein the one or more processors are configured to:
obtain, from the temperature sensor, a second sensor output indicating a second temperature associated with the device; and
resume the generation of the second output data at the LLM based on a determination that the second temperature is lower than a second temperature threshold.

9. The device of claim 8, wherein the one or more processors are configured to resume the generation of the second output data further based on a determination that a count of output tokens of the output data stored in the memory device is less than a token count threshold.

10. The device of claim 7, wherein the one or more processors are configured to pause the generation of the second output data for a duration that is based on the first temperature.

11. The device of claim 1, wherein the LLM is configured to generate the second output data based on the first output data, and wherein the one or more processors are configured to selectively, based on a difference between the first temperature and a temperature threshold, adjust a generation rate of the second output data at the LLM.

12. The device of claim 1, wherein the one or more processors are configured to generate audio data based on the first output data, the second output data, or both.

13. The device of claim 12, wherein the one or more processors are configured to selectively, based on the first temperature, update a generation rate of the audio data.

14. The device of claim 12, wherein the one or more processors are configured to selectively, based on the first temperature, reduce a generation rate of the audio data based on the first output data to pause the generation of the second output data.

15. The device of claim 12, further comprising a speaker coupled to the one or more processors and configured to output audio corresponding to the audio data.

16. The device of claim 1, wherein the LLM is configured to generate the second output data based on the first output data, and wherein the one or more processors are configured to configure the LLM to generate the second output data having a length that is based on the first temperature.

17. The device of claim 1, wherein the one or more processors are configured to generate an input embedding based on the first output data and the first temperature, the LLM configured to process the input embedding to generate the second output data.

18. The device of claim 1, wherein the one or more processors are configured to obtain, from a prompt encoder, a prompt embedding of an input prompt, the LLM configured to generate the first output data based on the prompt embedding.

19. A method comprising:
obtaining, from a temperature sensor, a sensor output indicating a temperature associated with a first device; and
based on the temperature and first output data of a large language model (LLM), controlling generation of second output data by the LLM.

20. A non-transitory computer-readable medium storing instructions that, when executed by one or more processors, cause the one or more processors to:
obtain, from a temperature sensor, a sensor output indicating a temperature associated with a device; and
based on the temperature and first output data of a large language model (LLM), control generation of second output data by the LLM.
